(19) United States
(12) Patent Application Publication
(10) Pub. No.: US 2026/0031753 A1
(43) Pub. Date: Jan. 29, 2026

(54) SEMICONDUCTOR DEVICE

(71) Applicant: Renesas Electronics Corporation, Tokyo (JP)

(72) Inventors: Takumi SANO, Tokyo (JP); Hiroyuki KOKUBUN, Tokyo (JP); Hiroshi SHIMADA, Tokyo (JP)

(21) Appl. No.: 19/256,866

(22) Filed: Jul. 1, 2025

(30) Foreign Application Priority Data
Jul. 25, 2024 (JP) 2024-120293

(51) Int. Cl. H02P 27/08; H02P 21/05; H02P 21/13; H02P 21/22; H02P 29/50

(52) U.S. Cl. CPC H02P 27/08; H02P 21/05; H02P 21/13; H02P 21/22; H02P 29/50

(57) ABSTRACT

A tracking filter includes an extraction multiplier, a low-pass filter, and a restoration multiplier. The extraction multiplier multiplies a tracking input signal by a cosine wave signal or a sine wave signal having a tracking frequency. The restoration multiplier generates a tracking output signal by multiplying an output signal of the low-pass filter by the cosine wave signal or the sine wave signal having the tracking frequency. The monitoring circuit detects an AC component included in the output signal of the low-pass filter, and determines whether or not the tracking filter is abnormal on the basis of a magnitude thereof.

### CROSS-REFERENCE TO RELATED APPLICATIONS

The disclosure of Japanese Patent Application No. 2024-120293 filed on Jul. 25, 2024 including the specification, drawings and abstract is incorporated herein by reference in its entirety.

### BACKGROUND

The present invention relates to a semiconductor device, for example, a semiconductor device having a tracking filter.

There is disclosed a technique listed below.

[Patent Document 1] Japanese Unexamined Patent Application Publication No. 2001-037287

Patent Document 1 discloses a control device capable of suppressing vibration having a frequency proportional to a rotation speed of a motor. The control device detects vibration with an acceleration sensor installed at a predetermined location, and extracts only a frequency component at which vibration is desired to be suppressed by using Fourier transform. The control device generates a compensation value for suppressing vibration having the extracted frequency component through repetitive control using a repetitive compensator, and adds the compensation value to a command value for the motor.

### SUMMARY

In general, in various systems, there is a case where it is desired to extract only a frequency component of a specific frequency from an input signal including a plurality of frequency components. As an example, in the motor system disclosed in Patent Document 1, only a frequency component of a frequency at which vibration is desired to be suppressed is extracted from a signal detected by the acceleration sensor. As described above, as a method of extracting only a frequency component of a specific frequency from an input signal, for example, a method using Fourier transform as disclosed in Patent Document 1 can be considered.

Specifically, a Fourier transformer extracts various frequency components included in an input signal. An inverse Fourier transformer restores a signal having only a frequency component of a specific frequency from among the frequency components extracted by the Fourier transformer. However, such a method using the Fourier transform requires complicated arithmetic processing including a window function and the like and a large memory capacity associated with the arithmetic operation. As a result, a system may be complicated. On the other hand, a method using a band-pass filter is also conceivable. However, the band-pass filter causes a phase delay, which complicates the design, especially when applied to a feedback system.

Therefore, as a method of easily extracting only a frequency component of a specific frequency, a method using a tracking filter is conceivable. However, since the tracking filter discriminates a specific frequency by using a low-pass filter, not only a frequency component of the specific frequency but also a frequency component in the vicinity thereof may be extracted. As described above, when neighboring frequency components are extracted, there is a possibility that malfunction occurs in a system equipped with a tracking filter, that is, a system that performs predetermined processing by using an output of the tracking filter.

Embodiments that will be described later have been made in view of such circumstances, and other problems and novel features will be apparent from the description of the present specification and the accompanying drawings.

A semiconductor device according to an embodiment includes a tracking filter and a monitoring circuit that monitors a processing state of the tracking filter. The tracking filter extracts a frequency component of a tracking frequency from a tracking input signal including a plurality of frequency components, and generates a tracking output signal including the extracted frequency component of the tracking frequency. The tracking filter includes an extraction multiplier, a low-pass filter, and a restoration multiplier. The extraction multiplier multiplies the tracking input signal by a cosine wave signal or a sine wave signal having the tracking frequency. The low-pass filter removes a frequency component higher than a cutoff frequency from an output signal of the extraction multiplier. The restoration multiplier multiplies an output signal of the low-pass filter by the cosine wave signal or the sine wave signal having the tracking frequency to generate the tracking output signal. Here, the monitoring circuit detects an AC component included in an output signal of the low-pass filter, and, determines whether or not the tracking filter is abnormal on the basis of a magnitude of the detected AC component.

According to the embodiment, it is possible to prevent malfunction of a system equipped with a tracking filter.

### BRIEF DESCRIPTION OF THE DRAWINGS

FIG. 1 is a block diagram illustrating a configuration example of a main part of a semiconductor device according to an embodiment.

FIG. 2 is a waveform diagram illustrating an ideal operation example of a tracking filter in FIG. 1.

FIG. 3 is a schematic diagram illustrating an example of a problem that may occur in the tracking filter in FIG. 1.

FIG. 4A is a schematic diagram illustrating an example of an output signal in a case where an ideal low-pass filter is used in FIG. 1.

FIG. 4B is a schematic diagram illustrating an example of an output signal in a case where an actual low-pass filter is used in FIG. 1.

FIG. 5 is a schematic diagram illustrating a configuration example of a motor system to which the semiconductor device according to one embodiment is applied.

FIG. 6 is a block diagram illustrating a detailed configuration example of the semiconductor device in FIG. 5.

FIG. 7A is a schematic diagram illustrating an example of torque vibration.

FIG. 7B is a diagram illustrating an example of a frequency spectrum of torque vibration illustrated in FIG. 7A.

FIG. 8 is a block diagram illustrating a detailed configuration example of a torque vibration compensator in FIG. 6.

FIG. 9 is a block diagram illustrating a detailed configuration example of a vibration component extractor in FIG. 8.

FIG. 10 is a schematic diagram illustrating a schematic operation example of a compensation value generation circuit in FIG. 8.

FIG. 11 is a schematic diagram illustrating an operation example of a second determination circuit in a case where a rotation speed of the motor is relatively high in FIG. 9.

FIG. 12 is a schematic diagram illustrating an operation example of the second determination circuit in a case where a rotation speed of the motor is relatively low in FIG. 9.

FIG. 13 is a schematic diagram illustrating an operation example of a first determination circuit in FIG. 9.

FIG. 14 is a schematic diagram illustrating a configuration example in which the torque vibration compensator illustrated in FIG. 8 is extended.

FIG. 15A is a flowchart illustrating an example of processing content of a main part of the torque vibration compensator illustrated in FIG. 14.

FIG. 15B is a flowchart illustrating an example of processing content subsequent to FIG. 15A.

FIG. 16 is a schematic diagram illustrating an example of processing content when determining whether or not a tracking output signal is in a steady state in FIG. 15A.

FIG. 17 is a schematic diagram illustrating a configuration example different from that in FIG. 14 in which the torque vibration compensator illustrated in FIG. 8 is extended.

FIG. 18A is a flowchart illustrating an example of processing content of a main part of a torque vibration compensator illustrated in FIG. 17.

FIG. 18B is a flowchart illustrating an example of processing content subsequent to FIG. 18A.

### DETAILED DESCRIPTION

In the following embodiments, when necessary for the sake of convenience, the description will be divided into a plurality of sections or embodiments, but unless otherwise specified, the sections or embodiments are not unrelated to each other, and one is in a relationship of some or all modifications, details, supplementary explanation, and the like of others. In addition, in the following embodiments, when mentioning the number of elements or the like (including number, numerical value, amount, range, and the like), the number of elements is not limited to a specific number unless otherwise specified or obviously limited to the specific number in principle, and the number of elements may be greater than or equal to or less than the specific number.

Furthermore, in the following embodiments, it goes without saying that the constituents (including element steps and the like) are not necessarily essential unless otherwise specified or considered to be obviously essential in principle. Similarly, in the following embodiments, when mentioning the shape, positional relationship, and the like of the constituents and the like, it is assumed to include those substantially approximate or similar to the shape and the like unless otherwise stated or unless clearly considered in principle. The same applies to the above numerical values and ranges.

Hereinafter, embodiments of the present invention will be described in detail with reference to the drawings. In all the drawings for describing the embodiments, the same members are denoted by the same reference numerals in principle, and repeated description thereof will be omitted.

### Outline of Semiconductor Device

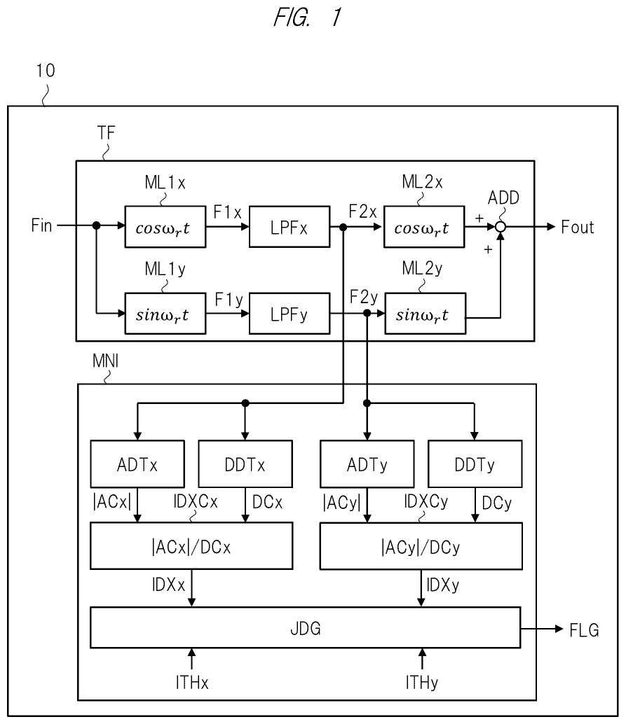

FIG. 1 is a block diagram illustrating a configuration example of a main part of a semiconductor device according to an embodiment. A semiconductor device 10 illustrated in FIG. 1 includes, for example, one semiconductor chip, and is provided as a constituent of a predetermined system. The semiconductor device 10 includes a tracking filter TF and a monitoring circuit MNI. The tracking filter TF and the monitoring circuit MNI are realized by, for example, a dedicated hardware circuit or a programmable logic device such as a field programmable gate array (FPGA).

Alternatively, the tracking filter TF and the monitoring circuit MNI may be realized by software processing. In this case, the semiconductor device 10 includes a memory that stores a program and a processor that executes the program stored in the memory. The processor causes the semiconductor device 10 to function as the tracking filter TF and the monitoring circuit MNI on the basis of the program.

### <<Details of Tracking Filter>>

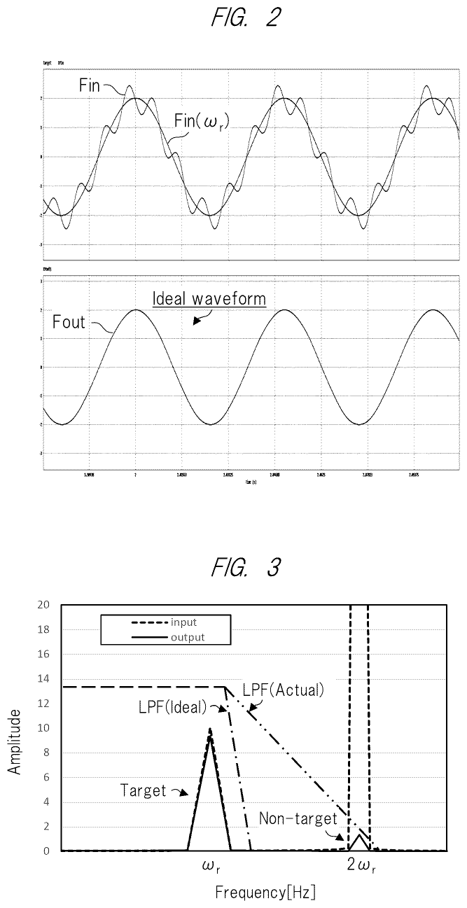

FIG. 2 is a waveform diagram illustrating an ideal operation example of the tracking filter TF in FIG. 1. Ideally, as illustrated in FIG. 2, the tracking filter TF extracts a frequency component Fin(ωᵣ) of a set tracking frequency or from a tracking input signal Fin including a plurality of frequency components. The tracking filter TF generates and outputs a tracking output signal Fout including only the extracted frequency component Fin(ωᵣ) of the tracking frequency ωᵣ.

In FIG. 1, the tracking filter TF specifically includes extraction multipliers ML1x and ML1y, low-pass filters LPFx and LPFy, restoration multipliers ML2x and ML2y, and an adder ADD. The extraction multipliers ML1x and ML1y multiply the tracking input signal Fin by a cosine wave signal (cos (ωᵣt)) or a sine wave signal (sin (ωᵣt)) having a tracking frequency ωᵣ. Specifically, the multiplier (first multiplier) ML1x generates an output signal F1x by multiplying by the cosine wave signal (cos (ωᵣt)). The multiplier (second multiplier) ML1y generates an output signal F1y by multiplying by the sine wave signal (sin (ωᵣt)).

The low-pass filters LPFx and LPFy may be first-order or second-order filters or higher-order filters. In a case where the low-pass filters LPFx and LPFy are configured by a digital circuit, for example, the low-pass filters LPFx and LPFy may be realized by an infinite impulse response (IIR) filter. The low-pass filters LPFx and LPFy allow frequency components lower than a cutoff frequency to pass therethrough and remove frequency components higher than the cutoff frequency from the output signals of the extraction multipliers ML1x and ML1y.

Specifically, the low-pass filter (first low-pass filter) LPFx receives the output signal F1x of the multiplier ML1x and generates a filtered output signal F2x. The low-pass filter (second low-pass filter) LPFy receives the output signal F1y of the multiplier ML1y and generates a filtered output signal F2y.

The restoration multipliers ML2x and ML2y multiply the output signals F2x and F2y of the low-pass filters LPFx and LPFy by the cosine wave signal (cos (ωᵣt)) or the sine wave signal (sin (ωᵣt)) having the tracking frequency ωᵣ. As a result, the tracking output signal Fout is generated via the adder ADD. Specifically, the multiplier ML2x multiplies the output signal F2x by the cosine wave signal (cos (ωᵣt)). The multiplier ML2y multiplies the output signal F2y by the sine wave signal (sin (ωᵣt)). The adder ADD generates the tracking output signal Fout by adding the output signals of the multipliers ML2x and ML2y. Here, further details of the tracking filter TF will be described. First, the tracking input signal Fin is expressed by Formula (1) by using a Fourier series. In Formula (1), “n” is an integer of 1 or more. “on” represents a frequency that changes by an integral multiple, specifically, an angular frequency. “aₙ” and “bₙ” are Fourier cosine and Fourier sine coefficients, respectively, at a frequency “ωₙ”. “A₀” is a DC component.

$$\begin{matrix}[ Math . 1 ] & \\ Fin = {A}_{0} + \sum ( {a}_{n} cos {ω}_{n} t + {b}_{n} sin {ω}_{n} t ) & ( 1 )\end{matrix}$$

The output signal F1x of the multiplier ML1x for extraction is expressed by Formula (2). The low-pass filter LPFx allows a frequency component of “ωₙ-ωᵣ” that is a low frequency to pass therethrough and removes a frequency component of “ωₙ+ωᵣ” that is a high frequency in Formula (2). As a result, the output signal F2x of the low-pass filter LPFx is expressed by Formula (3). In Formula (3), “ω′ᵣ” is a frequency near the tracking frequency ωᵣ. “aᵣ′/2” and “bᵣ′/2” are the amplitudes of the cosine and sine wave components, respectively, at the pass frequency “ω′ᵣ-ωᵣ”.

$$[ Math . 2 ]$$

$$F 1 x = Fin \times cos {ω}_{r} t = {A}_{0} cos {ω}_{r} t + \sum ( \frac{{a}_{n}}{2} \{ cos ( {ω}_{n} + {ω}_{r} ) t + cos ( {ω}_{n} - {ω}_{r} ) t \} + \frac{{b}_{n}}{2} \{ ( sin ( {ω}_{n} + {ω}_{r} ) t \} + sin ( {ω}_{n} - {ω}_{r} ) t \} ) \qquad ( 2 )$$

$$\begin{matrix}[ Math . 3 ] & \\ F 2 x = \frac{{a}_{{r}^{′}}}{2} cos ( {ω}_{r}^{′} - {ω}_{r} ) t + \frac{{b}_{{r}^{′}}}{2} sin ( {ω}_{r}^{′} - {ω}_{r} ) t & ( 3 )\end{matrix}$$

Similarly, the output signal F1y of the extraction multiplier ML1y is expressed by Formula (4). The low-pass filter LPFy allows a frequency component of “ωₙ−ωᵣ” that is a low frequency to pass therethrough and removes a frequency component of “ωₙ+ωᵣ” that is a high frequency in Formula (4). As a result, the output signal F2y of the low-pass filter LPFy is expressed by Formula (5) as in the case of Formula (3).

$$[ Math . 4 ]$$

$$F 1 y = Fin \times sin {ω}_{r} t = {A}_{0} sin {ω}_{r} t + \sum ( \frac{{a}_{n}}{2} \{ sin ( {ω}_{n} + {ω}_{r} ) t - sin ( {ω}_{n} - {ω}_{r} ) t \} + \frac{{b}_{n}}{2} \{ ( - cos ( {ω}_{n} + {ω}_{r} ) t + cos ( {ω}_{n} - {ω}_{r} ) t \} ) \qquad ( 4 )$$

$$\begin{matrix}[ Math . 5 ] & \\ F 2 y = - \frac{{a}_{{r}^{′}}}{2} sin ( {ω}_{r}^{′} - {ω}_{r} ) t + \frac{{b}_{{r}^{′}}}{2} cos ( {ω}_{r}^{′} - {ω}_{r} ) t & ( 5 )\end{matrix}$$

Here, in a case where the low-pass filters LPFx and LPFy are ideal, only a DC component is allowed to pass and an AC component is removed. That is, the ideal low-pass filters LPFx and LPFy extract only a DC component obtained by substituting “ω′ᵣ=ωᵣ” into Formulas (3) and (5). As a result, the output signals F2x and F2y of the ideal low-pass filters LPFx and LPFy are respectively represented by DC components DCx and DCy expressed by Formula (6).

$$\begin{matrix}[ Math . 6 ] & \\ \begin{matrix}F 2 x = DCx = \frac{{a}_{r}}{2} \\ F 2 y = DCy = \frac{{b}_{r}}{2}\end{matrix} & ( 6 )\end{matrix}$$

As a result, the output signals of the restoration multipliers ML2x and ML2y are expressed by Formulas (7) and (8), respectively. The tracking output signal Fout from the adder ADD is expressed by Formula (9). That is, the tracking output signal Fout is expressed by an addition result of the cosine wave signal having the amplitude “aᵣ/2” and the tracking frequency ωᵣ and the sine wave signal having the amplitude “bᵣ/2” and the tracking frequency ωᵣ.

$$\begin{matrix}[ Math . 7 ] & \\ F 2 x \times cos {ω}_{r} t = \frac{{a}_{r}}{2} cos {ω}_{r} t & ( 7 )\end{matrix}$$

$$\begin{matrix}[ Math . 8 ] & \\ F 2 y \times sin {ω}_{r} t = \frac{{b}_{r}}{2} sin {ω}_{r} t & ( 8 )\end{matrix}$$

$$\begin{matrix}[ Math . 9 ] & \\ Fout = \frac{{a}_{r}}{2} cos {ω}_{r} t + \frac{{b}_{r}}{2} sin {ω}_{r} t & ( 9 )\end{matrix}$$

### <<Problem of Tracking Filter>>

FIG. 3 is a schematic diagram illustrating an example of a problem that may occur in the tracking filter TF in FIG. 1. A case is assumed in which not only a frequency component of the tracking frequency or but also a frequency component near the tracking frequency or is included in the tracking input signal Fin. Typical examples of the frequency component near the tracking frequency ωᵣ include a harmonic component of the tracking frequency ωᵣ, that is, a distortion component that may be included in a cosine wave having the tracking frequency ωᵣ.

In the example illustrated in FIG. 3, a harmonic component having a second-order frequency (2ωᵣ) among harmonic components of the tracking frequency ωᵣ is illustrated. In particular, as the tracking frequency ωᵣ, that is, an extraction target frequency becomes lower, the closer a neighboring relationship between the tracking frequency ωᵣ and the second-order frequency (2ωᵣ).

Here, in the ideal low-pass filter LPF (Ideal), in order to extract only a DC component obtained by substituting “ω′ᵣ=ωᵣ” into Formulas (3) and (5), it is possible to form a steep filter characteristic after setting the cutoff frequency to substantially zero. As a result, as illustrated in FIG. 3, the ideal low-pass filter LPF(Ideal) can allow only the frequency component of the tracking frequency ωᵣ to pass therethrough and completely remove the frequency component of the second-order frequency (2ωᵣ).

However, in an actual low-pass filter LPF(Actual), it is usually difficult to realize such steep filter characteristics. As a result, the actual low-pass filter LPF(Actual) allows not only the frequency component of the tracking frequency ωᵣ to pass but also a part of the frequency component of the second-order frequency (2ωᵣ) to pass through according to the gentle filter characteristic as illustrated in FIG. 3.

As described above, in a case where the frequency component of the second-order frequency (2ωᵣ) cannot be removed, the output signals F2x and F2y of the low-pass filters LPFx and LPFy are expressed by Formulas (10) and (11), respectively. In Formula (10), the output signal F2x includes an AC component ACx obtained by substituting “ω′ᵣ=2ωᵣ” in addition to the DC component DCx (=aᵣ/2) obtained by substituting “ω′ᵣ=ωᵣ” into Formula (3). Similarly for Formula (11), the output signal F2y includes an AC component ACy in addition to the DC component DCy.

$$\begin{matrix}[ Math . 10 ] & \\ F 2 x = DCx + ACx = \frac{{a}_{r}}{2} + \frac{{a}_{2 r}^{′}}{2} cos {ω}_{r} t + \frac{{b}_{2 r}^{′}}{2} sin {ω}_{r} t & ( 10 )\end{matrix}$$

$$\begin{matrix}[ Math . 11 ] & \\ F 2 y = DCy + ACy = \frac{{b}_{r}}{2} - \frac{{a}_{2 r}^{′}}{2} sin {ω}_{r} t + \frac{{b}_{2 r}^{′}}{2} cos {ω}_{r} t & ( 11 )\end{matrix}$$

As a result, the output signals of the restoration multipliers ML2x and ML2y are expressed by Formulas (12) and (13), respectively. The tracking output signal Fout from the adder ADD is expressed by Equation (14). As shown in Formula (14), the tracking output signal Fout in a case where the frequency component of the second-order frequency (2ωᵣ) cannot be removed includes a frequency component of the second-order frequency (2ωᵣ) in addition to the frequency component of the tracking frequency ωᵣ shown in Formula (9). As a result, the tracking output signal Fout has, for example, a waveform obtained by adding distortion to the ideal waveform illustrated in FIG. 2.

$$\begin{matrix}[ Math . 12 ] & \\ F 2 x \times cos {ω}_{r} t = \frac{{a}_{r}}{2} cos {ω}_{r} t + \frac{{a}_{2 r}^{′}}{4} cos ( 2 {ω}_{r} ) t + \frac{{a}_{2 r}^{′}}{4} + \frac{{b}_{2 r}^{′}}{4} sin ( 2 {ω}_{r} ) t & ( 12 )\end{matrix}$$

$$\begin{matrix}[ Math . 13 ] & \\ F 2 y \times sin {ω}_{r} t = \frac{{b}_{r}}{2} sin {ω}_{r} t + \frac{{a}_{2 r}^{′}}{4} cos ( 2 {ω}_{r} ) t - \frac{{a}_{2 r}^{′}}{4} + \frac{{b}_{r}^{′}}{4} sin ( 2 {ω}_{r} ) t & ( 13 )\end{matrix}$$

$$\begin{matrix}[ Math . 14 ] & \\ Fout = \frac{{a}_{r}}{2} cos {ω}_{r} t + \frac{{b}_{r}}{2} sin {ω}_{r} t + \frac{{a}_{2 r}^{′}}{2} cos ( 2 {ω}_{r} ) t + \frac{{b}_{2 r}^{′}}{2} sin ( 2 {ω}_{r} ) t & ( 14 )\end{matrix}$$

As described above, when the tracking filter TF extracts not only the frequency component of the tracking frequency ωᵣ but also a neighboring frequency component, for example, a frequency component of the second-order frequency (2ωᵣ), malfunction may occur in the system equipped with the tracking filter TF. For example, the system that performs predetermined processing by using the tracking output signal Fout normally performs the predetermined processing on the assumption that the tracking output signal Fout includes only the frequency component of the tracking frequency ωᵣ. If this premise collapses, an unintended processing result may occur. Therefore, the monitoring circuit MNI illustrated in FIG. 1 is provided.

Note that the tracking filter TF is not limited to the configuration example illustrated in FIG. 1, and can be changed as appropriate. For example, there is a configuration in which extraction multipliers ML1x and ML1y are provided as a part of a rotating coordinate converter that performs conversion into rotating coordinates, and restoration multipliers ML2x and ML2y are provided as a part of a fixed coordinate converter that performs conversion into fixed coordinates. The tracking filter TF may include at least one of the extraction multipliers ML1x and ML1y, one of the low-pass filters LPFx and LPFy, and one of the restoration multipliers ML2x and ML2y, including such a configuration.

### <<Details of Monitoring Circuit>>

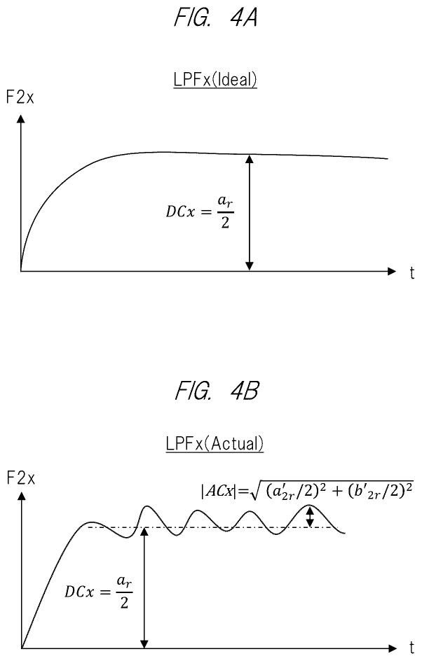

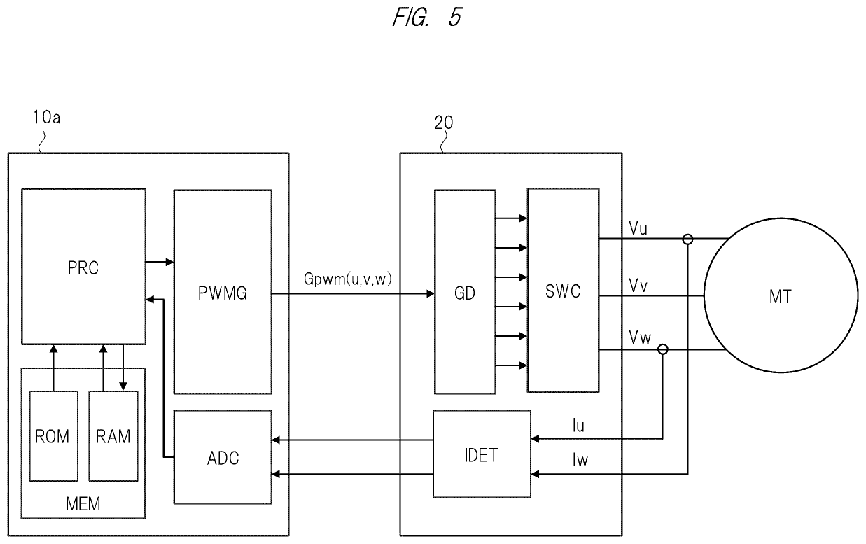

FIG. 4A is a schematic diagram illustrating an example of the output signal F2x in a case where the ideal low-pass filter LPFx in FIG. 1 is used. The output signal F2x illustrated in FIG. 4A rises at a predetermined rise time based on the characteristics of the low-pass filter LPFx, and then is stabilized in a state in which the DC component DCx (=aᵣ/2) shown in Formula (6) is output. Although not illustrated, the same applies to the output signal F2y.

FIG. 4B is a schematic diagram illustrating an example of the output signal F2x in a case where the actual low-pass filter LPFx in FIG. 1 is used. The output signal F2x illustrated in FIG. 4B rises at a predetermined rise time based on the characteristics of the low-pass filter LPFx, and as shown in Formula (10), is stabilized in a state in which an addition signal of the DC component DCx (=aᵣ/2) and the AC component ACx is output.

The magnitude (|ACx|) of the AC component ACx included in the output signal F2x, in other words, the amplitude is expressed by Formula (15) on the basis of Formula (10). Although not illustrated, the same applies to the output signal F2y. The magnitude (|ACy|) of the AC component ACy included in the output signal F2y, in other words, the amplitude is also expressed by Formula (15) on the basis of Formula (11).

$$\begin{matrix}[ Math . 15 ] & \\ \vert ACx \vert = \vert ACy \vert = \sqrt{{( {a}_{2 r}^{′} / 2 )}^{2} + {( {b}_{2 r}^{′} / 2 )}^{2}} & ( 15 )\end{matrix}$$

Here, the monitoring circuit MNI illustrated in FIG. 1 monitors a processing state of the tracking filter TF. Schematically, the monitoring circuit MNI detects the AC components ACx and ACy included in the output signals F2x and F2y of the low-pass filters LPFx and LPFy. The monitoring circuit MNI determines the presence or absence of abnormality in the tracking filter TF on the basis of the magnitudes (|ACx |, |ACy|) of the detected AC components ACx and ACy. The monitoring circuit MNI notifies a predetermined system of the determination result of the presence or absence of abnormality by using an abnormality flag signal FLG.

Specifically, the monitoring circuit MNI includes AC component detection circuits ADTx and ADTy, DC component detection circuits DDTx and DDTy, abnormality index calculation circuits IDXCx and IDXCy, and a determination circuit JDG. The AC component detection circuit ADTx, the DC component detection circuit DDTx, and the abnormality index calculation circuit IDXCx perform processing on the output signal F2x of the low-pass filter LPFx. The AC component detection circuit ADTy, the DC component detection circuit DDTy, and the abnormality index calculation circuit IDXCy perform processing on the output signal F2y of the low-pass filter LPFy.

With respect to the output signal F2x, the AC component detection circuit ADTx and the DC component detection circuit DDTx detect an AC component (first AC component) ACx and a DC component DCx included in the output signal F2x, respectively. In this case, the DC component detection circuit DDTx detects the DC component DCx illustrated in FIG. 4B, for example, by processing the output signal F2x by using a moving average filter or the like. The AC component detection circuit ADTx detects the AC component ACx illustrated in FIG. 4B, specifically, the magnitude (|ACx|) thereof, for example, by monitoring a peak value of the output signal F2x. Similarly, with respect to the output signal F2y, the AC component detection circuit ADTy and the DC component detection circuit DDTy detect the AC component (second AC component) ACy and the DC component DCy included in the output signal F2y.

As shown in Formula (16), the abnormality index calculation circuit IDXCx calculates, as an abnormality index IDXx, a ratio of the AC component ACx, specifically, the magnitude (|ACx|) of the AC component ACx to the DC component DCx. Similarly, the abnormality index calculation circuit IDXCy calculates, as an abnormality index IDXy, a ratio of the AC component ACy, specifically, the magnitude (|ACy|) of the AC component ACy to the DC component DCy as shown in Formula (16). The DC components DCx and DCy may have negative values. Therefore, the abnormality indexes IDXx and IDXy may be values obtained by converting values calculated by using Formula (16) into absolute values.

$$\begin{matrix}[ Math . 16 ] & \\ \begin{matrix}IDXx = \vert ACx \vert / DCx \\ IDXy = \vert ACy \vert / DCy\end{matrix} & ( 16 )\end{matrix}$$

Schematically, the determination circuit JDG determines whether or not the tracking filter TF is abnormal on the basis of the magnitude of at least one of the AC component ACx and the AC component ACy. Specifically, for example, the determination circuit JDG determines that there is an abnormality when the abnormality indexes IDXx and IDXy are more than predetermined thresholds (first thresholds) ITHx and ITHy, and determines that there is no abnormality when the abnormality indexes are less than the thresholds ITHx and ITHy. In this case, the determination circuit JDG may perform the determination under an AND condition for the two abnormality indexes IDXx and IDXy or may perform the determination under an OR condition. The determination circuit JDG notifies the system of the determination result on the presence or absence of abnormality by using the abnormality flag signal FLG.

Note that the monitoring circuit MNI may monitor only one of the output signals F2x and F2y. That is, the monitoring circuit MNI may have a configuration in which, for example, the AC component detection circuit ADTy, the DC component detection circuit DDTy, and the abnormality index calculation circuit IDXCy are not provided. However, in order to perform monitoring with higher reliability, it is desirable that the monitoring circuit MNI monitor both the output signals F2x and F2y.

By providing the monitoring circuit MNI as described above, it is possible to prevent malfunction of the system equipped with the tracking filter TF. That is, for example, in a case where the system performs predetermined processing on the basis of the tracking output signal Fout including a predetermined amount or more of frequency components of the second-order frequency (2ωᵣ) in Formula (14), the system can generate a processing result that is not originally intended. Therefore, when the tracking output signal Fout is regarded as abnormal, the system is notified by using the abnormality flag signal FLG. As a result, it is possible to prevent a situation in which an originally unintended processing result is generated.

Instead of the abnormality index IDXx representing the ratio (|ACx|/DCx) as illustrated in FIG. 1, the monitoring circuit MNI may simply determine the presence or absence of abnormality on the basis of the magnitude (|ACx|) of the AC component ACx. However, the magnitude (|ACx|) of the AC component ACx may change as appropriate according to, for example, a specification, an environment, and the like of the system. For example, in a motor system, the average magnitude (|ACx|) of the AC component, that is, the range may change according to a motor capacity, a specification of a load driven by the motor, and the like. As a result, it is necessary to set a plurality of thresholds ITHx according to the specification, environment, and the like of the system, which may cause complication of setting, deterioration in versatility, and the like.

From this viewpoint, it is more beneficial to use the abnormality index IDXx instead of the magnitude (|ACx|) of the AC component ACx. That is, in this case, the monitoring circuit MNI can determine the presence or absence of abnormality from the relative magnitude (|ACx|) of the AC component based on the DC component DCx. As a result, a single threshold ITHx can be used for general purposes. For example, in the motor system, the monitoring circuit MNI can discriminate the motor capacity from the DC component DCx, and determine the presence or absence of abnormality on the basis of the magnitude (|ACx|) of the AC component normalized by the discriminated motor capacity. As a result, for example, even when the motor capacity changes, the same threshold ITHx can be applied.

### Application Example to Motor System

FIG. 5 is a schematic diagram illustrating a configuration example of a motor system to which a semiconductor device according to an embodiment is applied. The motor system illustrated in FIG. 5 includes a semiconductor device 10a, an inverter 20, and a motor MT. The motor MT is, for example, a three-phase motor including a u phase, a v phase, and a w phase. The semiconductor device 10a generates and outputs a motor control signal for controlling the motor MT, for example, a pulse width modulation (PWM) signal Gpwm. The inverter 20 supplies AC power for each phase of the motor MT on the basis of the motor control signal. Although details will be described later, the configuration example illustrated in FIG. 1 is applied to a part of the semiconductor device 10a.

In this example, the semiconductor device 10a is, for example, a microcontroller or a system on chip (SoC) including one semiconductor chip. The semiconductor device 10a mainly includes a processor PRC, a memory MEM, a PWM signal generator PWMG, and an analog/digital converter ADC. The processor PRC is, for example, a central processing unit (CPU) or a digital signal processor (DSP). The memory MEM includes a read only memory (ROM) and a random access memory (RAM). The ROM is, for example, a flash memory. The RAM is, for example, an SRAM or a DRAM.

The ROM stores a motor control program. The motor control program is copied to the RAM. The processor PRC controls the motor MT by executing the motor control program copied to the RAM. The PWM signal generator PWMG generates a PWM signal Gpwm(u, V, w) for each phase on the basis of, for example, a duty ratio command value for each phase from the processor PRC. The analog/digital converter ADC receives a detection signal representing a state of the motor MT, in this example, a detection signal representing a phase current of the motor MT, via the inverter 20. The analog/digital converter ADC converts the detection signal into a digital value.

The inverter 20 includes a gate driver GD, a switching circuit SWC, and a current detector IDET. The switching circuit SWC includes, for example, a three-phase bridge circuit including six switching elements. The gate driver GD receives the PWM signal Gpwm(u, v, w) for each phase from the semiconductor device 10a, and controls on/off of the six switching elements in the switching circuit SWC on the basis of the PWM signal Gpwm(u, v, w). As a result, the switching circuit SWC supplies three-phase phase voltages Vu, Vv, and Vw corresponding to a duty ratio of the PWM signal to the motor MT.

The current detector IDET detects phase currents Iu and Iw flowing in at least two phases of the motor MT, in this example, the u-phase and the w-phase. The analog/digital converter ADC in the semiconductor device 10 converts the phase currents Iu and Iw detected by the current detector IDET into digital values. The phase current Iv flowing in the remaining one phase can be calculated from the relationship of “Iu+Iv+Iw=0”. Alternatively, the three-phase phase currents Iu, Iv, and Iw may be bundled and detected by one current detector. In this case, the current detector recognizes on/off states of the six switching elements on the basis of, for example, the PWM signal Gpwm(u, v, w), and detects a corresponding phase current on the basis of a combination of the on/off states.

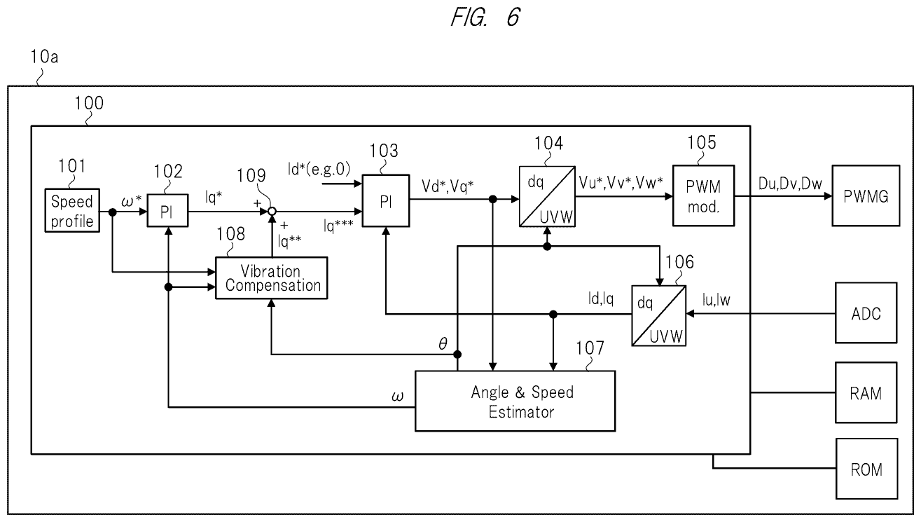

FIG. 6 is a block diagram illustrating a detailed configuration example of the semiconductor device 10a in FIG. 5. The semiconductor device 10a illustrated in FIG. 6 includes a motor controller 100 in addition to the PWM signal generator PWMG, the analog/digital converter ADC, the RAM, and the ROM illustrated in FIG. 5. The motor controller 100 is implemented by the processor PRC illustrated in FIG. 5 executing a motor control program stored in the RAM. In other words, the motor control program causes the processor PRC to function as each constituent in the motor controller 100 illustrated in FIG. 6.

The motor controller 100 includes a torque vibration compensator 108 and an adder 109 in addition to a speed commander 101, a speed controller 102, a current controller 103, a two-axis/three-axis converter 104, a PWM signal modulator 105, a three-axis/two-axis converter 106, and a rotation angle/speed estimator 107.

The three-axis/two-axis converter 106 receives the two-phase phase currents Iu and Iw from the analog/digital converter ADC and a rotation angle θ from the rotation angle/speed estimator 107. The three-axis/two-axis converter 106 converts the three-phase phase currents Iu, Iv, and Iw in the UVW coordinates obtained from the two-phase currents Iu and Iw into a d-axis current Id and a q-axis current Iq in the dq coordinates by Clarke transformation and Park transformation using the rotation angle θ. The UVW coordinates are rotational coordinates. On the other hand, the dq coordinates are fixed coordinates.

The speed commander 101 generates a speed command value ω* on the basis of, for example, a predetermined speed profile. The speed controller 102 performs, for example, proportional integral (PI) control or the like on the basis of a speed deviation between the speed command value ω* and a value of the rotation speed ω from the rotation angle/speed estimator 107. As a result, the speed controller 102 generates a q-axis current command value Iq* for bringing the speed deviation close to 0, in other words, a torque command value.

The adder 109 adds the q-axis current command value Iq* from the speed controller 102 and a q-axis current command value Iq ** from the torque vibration compensator 108, and outputs an addition result as a q-axis current command value Iq***. Although details will be described later, the torque vibration compensator 108 generates a torque compensation value for suppressing torque vibration as the q-axis current command value Iq** for vibration suppression on the basis of, for example, a speed deviation between the speed command value ω* and the value of the rotation speed ω from the rotation angle/speed estimator 107. Accordingly, the adder 109 adds a torque compensation value to the torque command value.

The current controller 103 receives the q-axis current command value Iq*** from the adder 109 and a d-axis current command value Id*. The d-axis current command value Id* is fixed to zero, for example. However, the d-axis current command value Id* may be a non-zero value generated on the basis of the flux weakening control or the “Maximum Torque Per Ampere” control. The current controller 103 performs PI control or the like on the basis of current deviations between the d-axis current command value Id* and the q-axis current command value Iq *** and the values of the d-axis current Id and the q-axis current Iq from the three-axis/two-axis converter 106. As a result, the current controller 103 generates a d-axis voltage command value Vd* and a q-axis voltage command value Vq* for bringing the current deviations close to 0.

The two-axis/three-axis converter 104 receives the d-axis voltage command value Vd* and the q-axis voltage command value Vq* from the current controller 103 and the rotation angle θ from the rotation angle/speed estimator 107. In this case, the rotation angle θ may be corrected in consideration of the rotation of the motor MT. The two-axis/three-axis converter 104 converts the d-axis voltage command value Vd* and the q-axis voltage command value Vq* in the dq coordinates into three-phase voltage command values Vu*, Vv*, and Vw* in the UVW coordinates through inverse Park transformation and inverse Clarke transformation using the rotation angle θ. The PWM signal modulator 105 converts the three-phase voltage command values Vu*, Vv*, and Vw* into three-phase duty ratio command values Du, Dv, and Dw, and outputs the three-phase duty ratio command values Du, Dv, and Dw to the PWM signal generator PWMG.

The rotation angle/speed estimator 107 receives the values of the d-axis current Id and the q-axis current Iq from the three-axis/two-axis converter 106, and the d-axis voltage command value Vd* and the q-axis voltage command value Vq* from the current controller 103. The rotation angle/speed estimator 107 calculates d-axis and q-axis induced voltages on the basis of these input values and a predetermined motor state equation. The rotation angle/speed estimator 107 calculates, in other words, estimates or detects the rotation angle θ on the basis of the calculated d-axis and q-axis induced voltages. Further, the rotation angle/speed estimator 107 calculates the rotation speed ω through differential calculation of the rotation angle θ. Note that the rotation angle/speed estimator 107 may calculate the rotation angle θ by calculating a magnetic flux instead of an induced voltage.

In FIG. 6, the motor controller 100 that performs the sensorless vector control is illustrated. However, the motor controller 100 may perform vector control using a sensor. In this case, a position/speed sensor is installed in the motor MT instead of the rotation angle/speed estimator 107. The position/speed sensor is, for example, a rotary encoder that detects the rotation angle θ and the rotation speed ω. In addition, here, the motor controller 100 is realized by program processing using the processor PRC. However, the motor controller 100 may be realized by using, for example, a field programmable gate array (FPGA) or an ASIC. That is, the semiconductor device 10a illustrated in FIG. 6 may be an FPGA, an ASIC, or the like.

### Torque Vibration

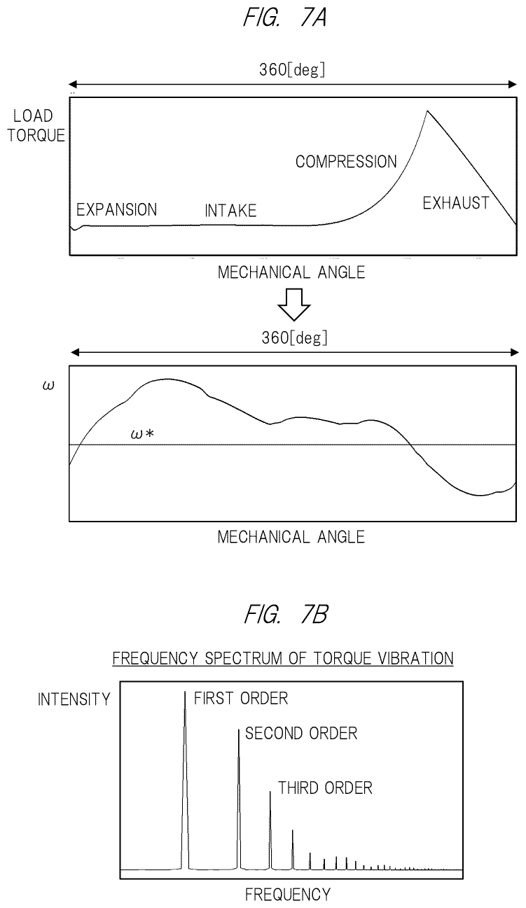

FIG. 7A is a schematic diagram illustrating an example of torque vibration. For example, in FIGS. 5 and 6, when torque as disturbance is applied to the motor MT, the rotation speed ω of the motor MT vibrates. Such vibration is called torque vibration. As a specific example, as illustrated in FIG. 7A, a compressor motor mounted on an a conditioner sequentially performs expansion, intake, compression, and exhaust of a refrigerant in a period in which the motor MT, specifically, a rotor rotates by 360 [deg] in a mechanical angle. Accordingly, load torque varies. Torque vibration may occur due to a difference between the load torque and the output torque.

The torque vibration is periodically generated according to the rotation angle that is a mechanical angle of the motor MT, in other words, a magnetic pole position, and changes the rotation speed ω of the motor MT. A frequency of the torque vibration is synchronized with the rotation speed ω of the motor MT. Thus, low-frequency torque vibration occurs at a low speed. In particular, the low-frequency torque vibration causes noise generation, a decrease in the life of the motor system, and the like in addition to deterioration in controllability. Therefore, it is desirable to suppress torque vibration.

FIG. 7B is a diagram illustrating an example of a frequency spectrum of the torque vibration illustrated in FIG. 7A. As illustrated in FIG. 7B, the waveform of the torque vibration illustrated in FIG. 7A is decomposed into first-order, second-order, third-order, and . . . frequency components. As illustrated in FIG. 7A, the first-order frequency component is a vibration component at a fundamental frequency having a time corresponding to a mechanical angle of 360 [deg] as one cycle. The second-order, third-order, . . . frequency components are vibration components at frequencies of two times, three times, . . . the fundamental frequency, and represent distortion components superimposed on the waveform of the fundamental frequency in the waveform of the torque vibration illustrated in FIG. 7A.

### Details of Torque Vibration Compensator

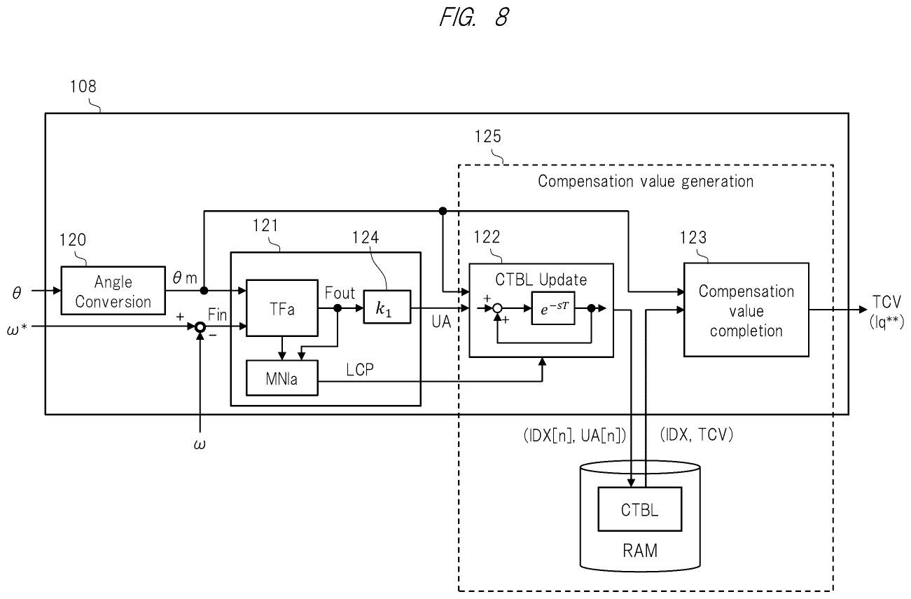

FIG. 8 is a block diagram illustrating a detailed configuration example of the torque vibration compensator 108 in FIG. 6. The torque vibration compensator 108 illustrated in FIG. 8 includes a rotation angle converter 120, a vibration component extractor 121, and a compensation value generation circuit 125. The rotation angle converter 120 converts the rotation angle θ that is an electrical angle from the rotation angle/speed estimator 107 illustrated in FIG. 6 into a mechanical angle θm on the basis of the number of poles of the motor MT.

The vibration component extractor 121 includes a tracking filter TFa and a monitoring circuit MNIa as illustrated in FIG. 1, and a multiplier 124 that multiplies a compensation value gain k₁. Although details will be described later, the vibration component extractor 121 extracts a torque vibration component as described in FIGS. 7A and 7B, specifically, an offset component for offsetting the torque vibration component as the tracking output signal Fout by using the tracking filter TFa. The vibration component extractor 121 multiplies the tracking output signal Fout by the compensation value gain k₁ to generate an update amount UA of a torque compensation value TCV for offsetting the torque vibration component, and outputs the generated update amount UA to the compensation value generation circuit 125.

In this example, the compensation value generation circuit 125 includes a compensation value table update circuit 122 and a compensation value complement circuit 123. In addition, the compensation value generation circuit 125 stores a compensation value table CTBL in a memory MEM, specifically, in a RAM. Although details will be described later, the compensation value generation circuit 125 sequentially updates and generates the torque compensation value TCV for suppressing the torque vibration by performing a learning operation using the update amount UA based on the tracking output signal Fout as an input. The compensation value generation circuit 125 outputs the generated torque compensation value TCV as the q-axis current command value Iq ** for vibration suppression illustrated in FIG. 6 to reflect the torque compensation value TCV in the PWM signal Gpwm that is a motor control signal.

### <<Details of Vibration Component Extractor>>

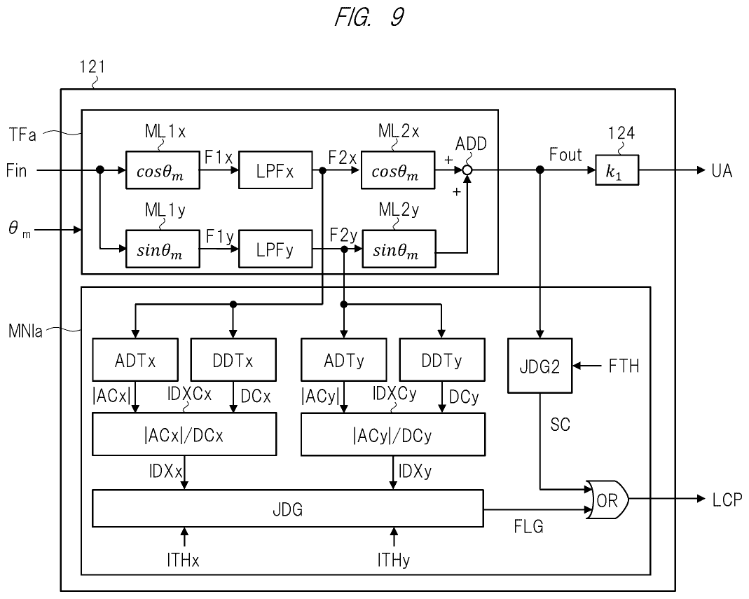

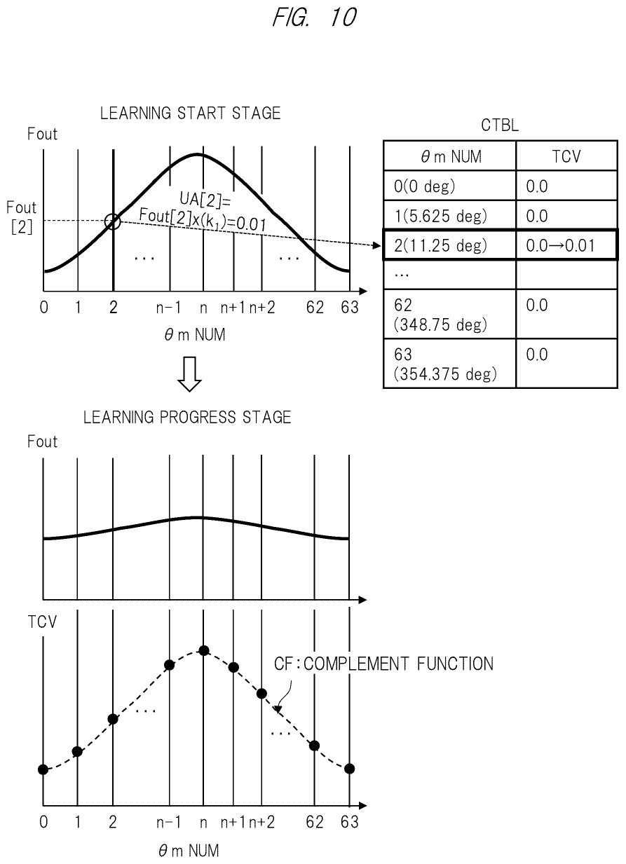

FIG. 9 is a block diagram illustrating a detailed configuration example of the vibration component extractor 121 in FIG. 8. In FIG. 9, the tracking filter TFa has a configuration similar to that in FIG. 1. However, in this example, as illustrated in FIGS. 6 and 8, the tracking filter TFa receives a speed deviation between the speed command value ω* from the speed commander 101 and the value of the rotation speed ω from the rotation angle/speed estimator 107 as the tracking input signal Fin. As a result, as illustrated in FIG. 7A, the tracking input signal Fin represents torque vibration that is also a change in the rotation speed ω based on the speed command value ω*.

Specifically, the tracking filter TFa receives the tracking input signal Fin obtained by using the values of the speed command value ω* and the rotation speed ω as a positive pole input and a negative pole input, respectively. As a result, specifically, the tracking input signal Fin becomes a signal that offsets the speed deviation, and becomes, for example, a signal that forms line symmetry with the signal of the rotation speed ω with the speed command value ω* as the center line in FIG. 7A. By using such a speed deviation as the tracking input signal Fin, for example, an acceleration sensor as disclosed in Patent Document 1 becomes unnecessary, and the cost can be reduced.

The tracking filter TFa receives the mechanical angle Om from the rotation angle converter 120. The tracking filter TFa applies the input mechanical angle θm to “ωᵣt” of each of the multipliers ML1x, ML1y, ML2x, and ML2y illustrated in FIG. 1, that is, a rotation angle that changes on the basis of the tracking frequency ωᵣ. As a result, the tracking filter TFa can extract a frequency component of the fundamental frequency (first order) with the fundamental frequency corresponding to one cycle of the mechanical angle θm described in FIGS. 7A and 7B as the tracking frequency ωr.

The tracking filter TFa ideally generates the tracking output signal Fout including the extracted frequency component, here, the frequency component of the fundamental frequency (first order). The tracking output signal Fout is a signal that offsets a frequency component of a fundamental frequency (first order) included in the detected torque vibration. Note that the tracking TFa can also extract second-order, third-order, . . . frequency components by doubling, tripling, . . . the input mechanical angle θm, and can also generate the tracking output signal Fout corresponding to each component.

The monitoring circuit MNIa includes a second determination circuit JDG2 and an OR operation circuit OR in addition to the configuration illustrated in FIG. 1. The second determination circuit JDG2 detects an amplitude of the tracking output signal Fout through envelope detection or the like, and determines whether or not the suppression of the torque vibration has been completed or the suppression has not been completed on the basis of the magnitude of the detected output amplitude. The second determination circuit JDG2 outputs a suppression completion signal SC indicating a determination result.

Specifically, first, the second determination circuit JDG2 determines the magnitude of the output amplitude of the tracking output signal Fout detected at the start stage of the learning operation performed by the compensation value generation circuit 125 as a pre-suppression amplitude. The second determination circuit JDG2 sequentially calculates a ratio of the detected output amplitude to the pre-suppression amplitude as a suppression ratio while sequentially detecting the output amplitude in the process of the learning operation. The second determination circuit JDG2 determines that the suppression has been completed when the calculated suppression ratio is lower than a predetermined threshold (second threshold) FTH, and determines that the suppression has not been completed when the calculated suppression ratio is higher than the threshold FTH.

The OR operation circuit OR outputs, in other words, asserts, a learning completion signal LCP when at least one of the suppression completion signal SC or the abnormality flag signal FLG is output, in other words, asserted. That is, the monitoring circuit MNIa outputs the learning completion signal LCP via the OR operation circuit OR in a first case or a second case. The first case is a case where it is determined that the suppression has been completed in the torque vibration on the basis of the suppression completion signal SC. The second case is a case where the tracking filter TFa determines that there is abnormality on the basis of the abnormality flag signal FLG.

### <<Details of Compensation Value Generation Circuit>>

FIG. 10 is a schematic diagram illustrating a schematic operation example of the compensation value generation circuit 125 in FIG. 8. In FIG. 10, in the compensation value table CTBL, a torque compensation value TCV for each rotation angle, specifically, for each mechanical angle θm, which is a discrete value, is registered. In the present specification, the discrete rotation angle of the motor MT registered in the compensation value table CTBL will also be referred to as a discrete rotation angle θm. In this example, the discrete rotation angle θm is represented by 64 index numbers NUM[0], [1], and [63] corresponding to one rotation. In this case, the mechanical angle θm between the adjacent index numbers NUM, that is, a resolution is 5.625 (=360/64) [deg].

Accordingly, for example, the discrete rotation angles θm corresponding to the first index number NUM [0] and the last index number NUM[63] are 0 [deg] and 354.375 [deg], respectively. In addition, here, since the repetitive control is performed in the cycle of the mechanical angle θm of 360 [deg], the index number NUM next to the last index number NUM[63] is the first index number NUM[0]. The compensation value table update circuit 122 sequentially updates the compensation value table CTBL on the basis of the update amount UA from the vibration component extractor 121. That is, the compensation value table CTBL is sequentially updated through the learning operation.

Specifically, for example, when the mechanical angle θm of the motor MT reaches a certain discrete rotation angle θm, the vibration component extractor 121 performs arithmetic processing by using the discrete rotation angle θm to output the update amount UA corresponding to the discrete rotation angle θm. As a specific example, it is assumed that the mechanical angle θm reaches the discrete rotation angle θm corresponding to the index number NUM[2], that is, 11.25 [deg] in the learning start stage illustrated in FIG. 10.

In this case, for example, the tracking filter TFa outputs an offset value Fout[2] at 11.25 [deg] in the tracking output signal Fout for offsetting the frequency component of the fundamental frequency (first order) included in the torque vibration. The vibration component extractor 121 outputs “0.01”, which is the update amount UA[2], by multiplying the compensation value gain k₁ to the offset value Fout[2].

In response to this, the compensation value table update circuit 122 adds “0.01” that is an update amount UA[2] to “0.0” that is the current torque compensation value TCV at the index number NUM[2] in the compensation value table CTBL. In the subsequent index numbers NUM[3], [4], . . . , the same processing as in the case of the index number NUM[2] is performed. As described above, the compensation value table update circuit 122 updates the compensation value table CTBL by integrating the update amount UA for each discrete rotation angle θm for each discrete rotation angle θm, that is, for each index number NUM.

On the other hand, the compensation value complement circuit 123 sequentially calculates a complement function CF representing a relationship between the mechanical angle θm and the torque compensation value TCV on the basis of the sequentially updated compensation value table CTBL. The compensation value complement circuit 123 calculates the torque compensation value TCV by substituting the input mechanical angle θm into the complement function CF, and outputs the torque compensation value TCV as the q-axis current command value Iq** for vibration suppression illustrated in FIG. 6. As a result, the torque compensation value TCV is reflected in the PWM signal Gpwm that is a motor control signal.

Here, the tracking output signal Fout substantially represents an offset component corresponding to the torque vibration component still remaining after the current torque compensation value TCV is reflected in the control of the motor

MT. Therefore, as illustrated in FIG. 10, the amplitude of tracking output signal Fout decreases every time the learning operation of compensation value table CTBL progresses and the suppression of the torque vibration component progresses accordingly. Accordingly, the torque compensation value TCV registered in the compensation value table CTBL converges to a predetermined value.

In addition, the torque compensation value TCV for each discrete rotation angle θm is registered in the compensation value table CTBL in order to reduce the necessary memory capacity. However, the compensation value complement circuit 123 needs to receive the mechanical angle θm that changes substantially continuously and output the torque compensation value TCV. Therefore, as illustrated in FIG. 10, the compensation value complement circuit 123 calculates the complement function CF for converting a discrete value into a continuous value. The complement function CF may be, for example, a function obtained by performing polynomial approximation on the torque compensation value TCV for every discrete rotation angle θm. Alternatively, the complement function CF may be, for example, a first-order interpolation function or a second-order interpolation function that interpolates between two adjacent torque compensation values TCV.

Note that the compensation value generation circuit 125 only needs to be a circuit that repeatedly generates the torque compensation value TCV by performing learning operations such as integral compensation and proportional integral compensation by using the tracking output signal Fout as an input, and is not particularly limited to the configuration illustrated in FIG. 8. For example, the compensation value generation circuit 125 may be a repetitive compensator as disclosed in Patent Document 1.

### <<Learning Completion Signal>>

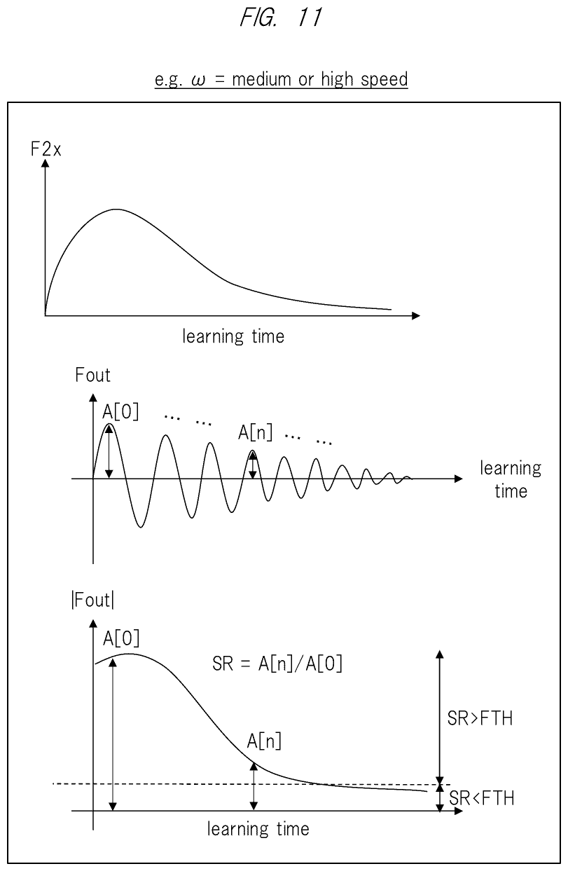

FIG. 11 is a schematic diagram illustrating an operation example of the second determination circuit JDG2 in a case where the rotation speed of the motor is relatively high in FIG. 9. In FIG. 11, for example, the output signal F2x of the low-pass filter LPFx rises through a predetermined control delay, and then gradually decreases as the learning operation in the compensation value generation circuit 125 and eventually the suppression of the torque vibration proceed. The same applies to the output signal F2y of the low-pass filter LPFy.

Here, in a case where the rotation speed ω of the motor MT is a medium speed or a high speed, for example, in FIG. 3, an interval between “ωᵣ” and “2ωᵣ” becomes relatively wide. As a result, as illustrated in FIG. 11, the output signal F2x does not include the AC component ACx as illustrated in FIG. 4B but includes only the DC component DCx. The tracking output signal Fout becomes a signal that gradually attenuates as the learning operation proceeds on the basis of such an output signal F2x.

As illustrated in FIG. 11, the second determination circuit JDG2 sets the magnitude (|Fout|) of the output amplitude of the tracking output signal Fout detected at the start stage of the learning operation as a pre-suppression amplitude A[0]. The second determination circuit JDG2 sequentially calculates a ratio of the detected output amplitude A[n] to the pre-suppression amplitude A[0] as a suppression ratio SR (=A[n]/A[0]) while sequentially detecting the output amplitude A[n] in the process of the learning operation. The second determination circuit JDG2 determines that the suppression has been completed when the suppression ratio SR is lower than the threshold FTH, and determines that the suppression has not been completed when the suppression ratio SR is higher than the threshold FTH.

In the example illustrated in FIG. 11, the suppression ratio SR is lower than the threshold FTH at a certain time point. Thus, second determination circuit JDG2 determines that the suppression has been completed, and outputs suppression completion signal SC. As a result, the monitoring circuit MNIa outputs the learning completion signal LCP via the OR operation circuit OR.

On the other hand, the compensation value generation circuit 125 illustrated in FIG. 8 completes the learning operation as described with reference to FIG. 10 in response to the learning completion signal LCP. In the example illustrated in FIG. 10, the compensation value generation circuit 125 stops the update operation of the compensation value table CTBL to complete the learning operation. The compensation value generation circuit 125 continuously reflects the torque compensation value TCV at the time point at which the learning operation has been completed, that is, the torque compensation value TCV based on the compensation value table CTBL at the time point at which the learning operation has been completed, in the motor control signal.

In motor systems, regular torque vibration may typically occur constantly. Thus, the torque vibration compensator 108 suppresses the torque vibration while generating the torque compensation value TCV for offsetting the torque vibration through the learning operation, and constructs a stable state in which the torque vibration is sufficiently suppressed. Thereafter, the torque vibration compensator 108 completes the learning operation, and maintains the stable state by continuously reflecting the torque compensation value TCV at that time point in the motor control signal. In the stable state, since the update amount UA of the torque compensation value TCV can be zero, it is not necessary to perform an unnecessary learning operation.

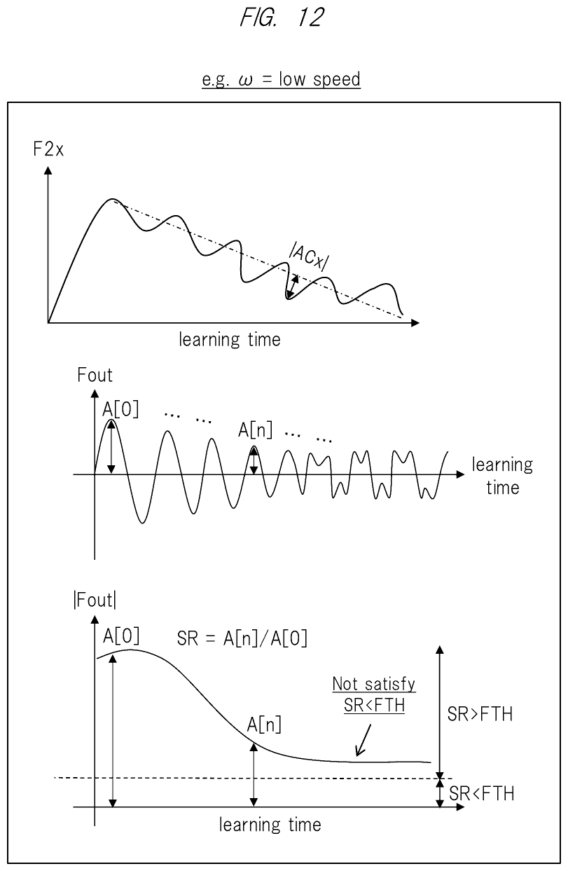

FIG. 12 is a schematic diagram illustrating an operation example of the second determination circuit JDG2 in a case where the rotation speed of the motor is relatively low in FIG. 9. In a case where the rotation speed ω of the motor MT is low, for example, in FIG. 3, an interval between “ωᵣ” and “2ωᵣ” becomes relatively narrow. As a result, unlike the case in FIG. 11, the output signal F2x of the low-pass filter LPFx becomes a signal in which the AC component ACx as illustrated in FIG. 4B is superimposed on the DC component DCx that gradually decreases as illustrated in FIG. 12.

Here, the motor system forms a negative feedback system to suppress the torque vibration at the tracking frequency ωᵣ via the torque vibration compensator 108. Thus, the frequency component of the tracking frequency ωᵣ included in the tracking output signal Fout, that is, the first-order (ωᵣ) frequency component is suppressed as the learning operation progresses.

On the other hand, for example, the phase characteristic of the feedback system is different for the second-order (2ωᵣ) frequency component from the case of the first-order (ωᵣ) frequency component. Thus, the motor system does not necessarily form a negative feedback system, and may form a positive feedback system in some cases. As a result, the second-order (2ωᵣ) frequency component included in the tracking output signal Fout is not necessarily suppressed even if the learning operation progresses, and may be amplified in some cases.

For this reason, in the tracking output signal Fout, as the learning operation progresses, the influence of the second-order (2ωᵣ) frequency component, that is, the influence of the AC component ACx becomes relatively large. Accordingly, the magnitude (|Fout|) of the output amplitude of the tracking output signal Fout decreases only to a certain extent due to the influence of the AC component ACx even if the learning operation proceeds, and may increase in some cases.

As a result, the following problems may mainly occur. As a first problem, as illustrated in FIG. 12, since the suppression ratio SR is not lower than the threshold FTH, the suppression completion signal SC is not output and the learning operation is not completed. As a countermeasure, when the threshold FTH is set high, the suppression of the torque vibration is insufficient. As a second problem, erroneous learning may occur. For example, there is a possibility that a learning operation for maintaining or amplifying a new torque vibration source is performed by using the second-order (2ωᵣ) frequency component included in the tracking output signal Fout as the new torque vibration source. When such a learning operation is continued, for example, there is a possibility of causing an unexpected abnormality such as overcurrent.

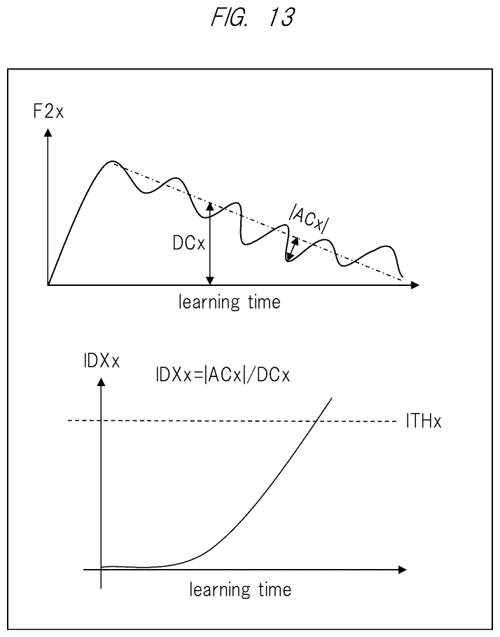

Therefore, the abnormality flag signal FLG from the determination circuit (first determination circuit) JDG illustrated in FIG. 9 is used together. FIG. 13 is a schematic diagram illustrating an operation example of the first determination circuit JDG in FIG. 9. In FIG. 13, the output signal F2x of the low-pass filter LPFx is a signal in which the AC component ACx is superimposed on the DC component DCx that gradually decreases, similarly to the case of FIG. 12. The abnormality index calculation circuit IDXCx calculates a ratio of the AC component ACx, more specifically, the magnitude (|ACx|) thereof to the DC component DCx as an abnormality index IDXx.

As a result, as illustrated in FIG. 13, the abnormality index IDXx becomes a value that increases as the learning operation progresses. The first determination circuit JDG determines that there is an abnormality when the abnormality index IDXx is higher than a predetermined threshold (first threshold) ITHx, and determines that there is no abnormality when the abnormality index IDXx is lower than the threshold ITHX. Therefore, as illustrated in FIG. 13, the first determination circuit JDG determines that there is an abnormality at a predetermined time point at which the learning operation progresses, and outputs the abnormality flag signal FLG. The monitoring circuit MNIa outputs the learning completion signal LCP in response to the abnormality flag signal FLG. The compensation value generation circuit 125 completes the learning operation in response to the learning completion signal LCP, and continuously reflects the torque compensation value TCV at the time point at which the learning operation has been completed in the motor control signal.

As described above, by using the suppression completion signal SC and the abnormality flag signal FLG in combination, even in a case where the suppression completion signal SC is not output, the learning operation is completed at a stage at which the suppression of the first-order (ωᵣ) frequency component has progressed to some extent. As a result, it is possible to prevent a situation in which erroneous learning as described in FIG. 12 progresses, and it is possible to prevent occurrence of unexpected abnormality such as overcurrent. In addition, the learning operation can be effectively used in the region of various rotation speeds ω. That is, completion of the learning operation can be determined by using the suppression completion signal SC in the medium speed or high speed range, and can be determined by using the abnormality flag signal FLG in the low speed range.

### Torque Vibration Compensator (Application Example[1])

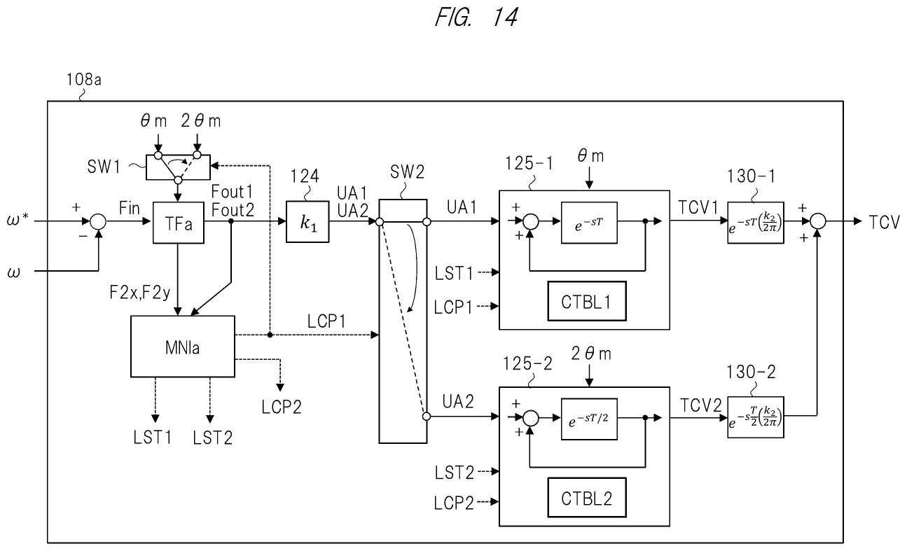

FIG. 14 is a schematic diagram illustrating a configuration example in which the torque vibration compensator illustrated in FIG. 8 is extended. In a torque vibration compensator 108a illustrated in FIG. 14, a plurality of tracking frequencies are provided by extending the configuration example in FIG. 8. In this example, a second-order tracking frequency (2ωᵣ) is provided in addition to the first-order tracking frequency ωᵣ. Accordingly, the torque vibration compensator 108a includes two changeover switches SW1 and SW2 and two compensation value generation circuits 125-1 and 125-2.

The changeover switch SW1 selects one of a mechanical angle θm and a double mechanical angle (2θm) on the basis of a first learning completion signal LCP1 from the monitoring circuit MNIa, and outputs the selected one to the tracking filter TFa. The double mechanical angle (2θm) is generated by, for example, the rotation angle converter 120 illustrated in FIG. 8. The changeover switch SW2 outputs the update amount UA from the multiplier 124, here, a first update amount UA1 or a second update amount UA2 to one of the two compensation value generation circuits 125-1 and 125-2 on the basis of a first learning completion signal LCP1.

Schematically, the tracking filter TFa generates two tracking output signals Fout1 and Fout2 in a time division manner by switching between the mechanical angle θm and the double mechanical angle (2θm) via the changeover switch SW1. In other words, the tracking filter TFa generates two tracking output signals Fout1 and Fout2 in a time division manner by switching between the first-order tracking frequency ωᵣ and the second-order tracking frequency (2θᵣ).

Specifically, first, the tracking filter TFa generates the first tracking output signal Fout1 by using the first-order tracking frequency ωᵣ by receiving the mechanical angle θm. Thereafter, the tracking filter TFa receives the double mechanical angle (2θm) instead of the mechanical angle θm in response to the learning completion signal LCP1 from the monitoring circuit MNIa. Therefore, the tracking filter TFa generates the second tracking output signal Fout2 by using the second-order tracking frequency (2ωᵣ). The multiplier 124 receives the first tracking output signal Fout1 and the second tracking output signal Fout2, and generates the first update amount UA1 and the second update amount UA2.

The compensation value generation circuit 125-1 receives the first update amount UA1 from the changeover switch SW2 and the first tracking output signal Fout1 as inputs, and starts a first learning operation using a first compensation value table CTBL1. More specifically, the compensation value generation circuit 125-1 starts the first learning operation in response to the first learning start signal LST1 from the monitoring circuit MNIa. Thereafter, the compensation value generation circuit 125-1 completes the first learning operation in response to the first learning completion signal LCP1, and continuously reflects the first torque compensation value TCVI at the time point at which the learning operation has been completed in the motor control signal.

On the other hand, in response to first learning completion signal LCP1, the changeover switch SW2 switches an output destination from the compensation value generation circuit 125-1 to the compensation value generation circuit 125-2. The compensation value generation circuit 125-2 receives the second update amount UA2 from the changeover switch SW2 and the second tracking output signal Fout2 as inputs, and starts a second learning operation using the second compensation value table CTBL2. More specifically, the compensation value generation circuit 125-2 starts the second learning operation in response to the second learning start signal LST2 from the monitoring circuit MNIa.

Thereafter, the compensation value generation circuit 125-2 completes the second learning operation in response to the second learning completion signal LCP2 from the monitoring circuit MNIa, and continuously reflects the second torque compensation value TCV2 at the time point at which the learning operation has been completed in the motor control signal. The second torque compensation value TCV2 is a value that changes at a frequency twice the first torque compensation value TCV1. Note that details of the first learning start signal LST1 and the second learning start signal LST2 will be described later.

Here, on the basis of the configuration example illustrated in FIG. 8, for example, the compensation value table update circuit 122 may be shared by two compensation value generation circuits 125-1 and 125-2. However, the compensation value table CTBL and the compensation value complement circuit 123 are individually provided by the two compensation value generation circuits 125-1 and 125-2.

Furthermore, in the example illustrated in FIG. 14, the two torque compensation values TCV1 and TCV2 are added via lead compensators 130-1 and 130-2 and then output as a torque compensation value TCV. For example, in a case where the compensation value generation circuit 125-1 outputs the first torque compensation value TCV1 corresponding to a certain mechanical angle θm, the first torque compensation value TCV1 is reflected in the motor MT through a predetermined control delay. However, when the actual mechanical angle θm of the motor MT advances during this control delay period, a deviation may occur in the mechanical angle θm. The lead compensators 130-1 and 130-2 compensate for such a deviation. Note that the lead compensator can also be applied to the configuration example illustrated in FIG. 8.

By using the above configuration example, for example, it is possible to suppress the first-order frequency component and the second-order frequency component included in the torque vibration as illustrated in FIG. 7B. In this case, for example, as illustrated in FIG. 12, when the learning completion signal LCP is generated on the basis of only the suppression ratio SR, the first learning completion signal LCP1 in FIG. 14 is not output, so that the switching to the second-order tracking frequency (2ωᵣ) is not performed. Therefore, when the abnormality index IDXx as illustrated in FIG. 13 is used together, switching to the second-order tracking frequency (2ωᵣ) is performed, and as a result, the second-order frequency component included in the torque vibration can also be suppressed.

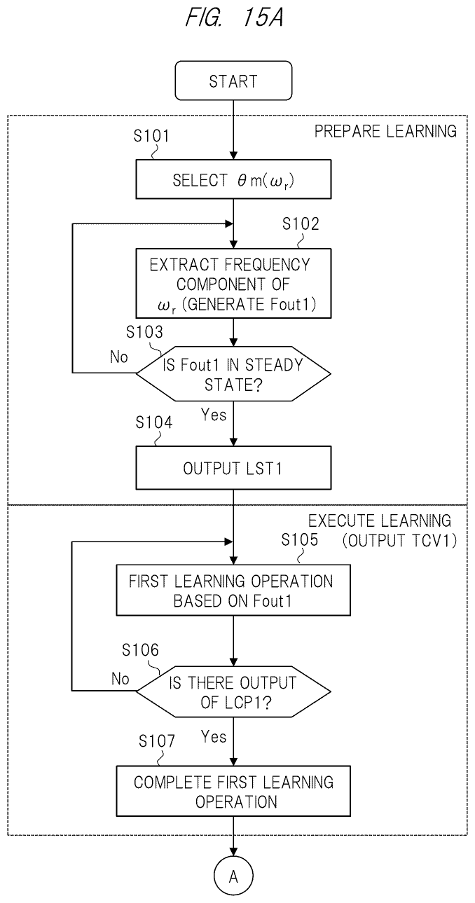

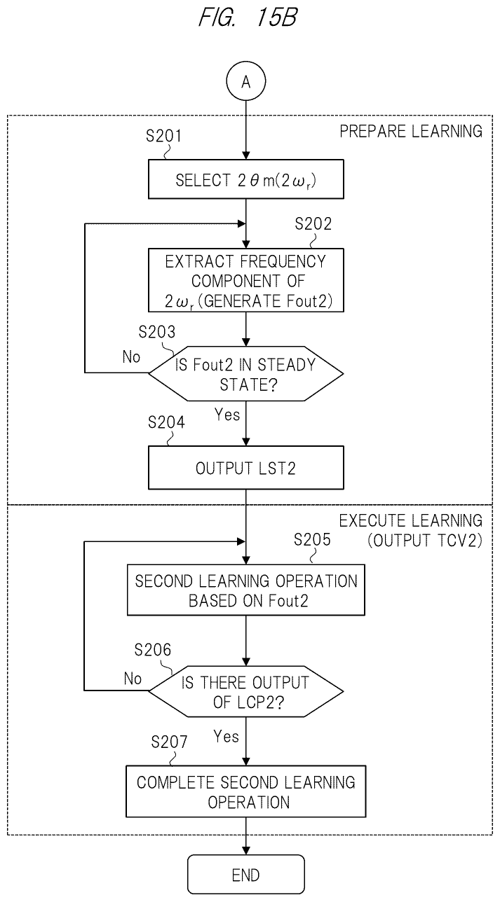

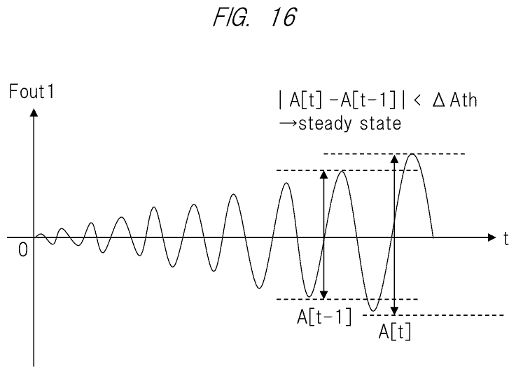

FIG. 15A is a flowchart illustrating an example of processing content of a main part of the torque vibration compensator 108a illustrated in FIG. 14. FIG. 15B is a flowchart illustrating an example of processing content subsequent to FIG. 15A. For example, the processor PRC in FIG. 5 executes such processing on the basis of a program in the memory MEM. FIG. 16 is a schematic diagram illustrating an example of processing content when determining whether or not the tracking output signal is in a steady state in FIG. 15A.

In FIG. 15A, steps S101 to are processes for preparation of the first learning operation. Steps S105 to S107 are processes associated with execution of the first learning operation. In step S101, the torque vibration compensator 108a selects the mechanical angle θm, that is, the first-order tracking frequency ωᵣ by using the changeover switches SW1 and SW2. Accordingly, the tracking filter TFa generates the first tracking output signal Fout1 by extracting a frequency component of the first-order tracking frequency ωᵣ included in the torque vibration (step S102).

Subsequently, the torque vibration compensator 108a waits for the first tracking output signal Fout1 to reach a steady state (step S103). That is, the first tracking output signal Fout1 reaches the steady state after a certain period of time from the operation start time point on the basis of the rising characteristics of the tracking filter TFa. The torque vibration compensator 108a can correctly detect the magnitude of the torque vibration at a stage at which the first tracking output signal Fout1 rises to the steady state.

Therefore, as illustrated in FIG. 16, while sequentially detecting the amplitude of the first tracking output signal Fout1, the monitoring circuit MNIa determines whether or not a difference between the previous amplitude A[t−1] and the current amplitude A[t] is less than a predetermined difference threshold ΔAth, for example. When “|A[t]-A[t−1]<|ΔAth” is satisfied, the monitoring circuit MNIa determines that the first tracking output signal Fout is in the steady state.

Referring to FIG. 15A again, in a case where it is determined that the first tracking output signal Fout1 is in the steady state (step S103: Yes), the monitoring circuit MNIa outputs the first learning start signal LST1 (step S104). In addition, for example, the monitoring circuit MNIa sets the output amplitude of the first tracking output signal Fout1 at the time point at which the state is determined to be the steady state to the pre-suppression amplitude A[0] illustrated in FIG. 11.

On the other hand, the compensation value generation circuit 125-1 receives the first update amount UA1 via the changeover switch SW2. In response to the first learning start signal LST1 in step S104, the compensation value generation circuit 125-1 starts the first learning operation on the basis of the first update amount UA1 and the first tracking output signal Fout1 (step S105). The compensation value generation circuit 125-1 sequentially updates and outputs the first torque compensation value TCV1 in accordance with the first learning operation.

As a result, since the torque vibration is sequentially suppressed, the monitoring circuit MNIa outputs the first learning completion signal LCP1 at any time point. In a case where the first learning completion signal LCP1 is output (step S106: Yes), the compensation value generation circuit 125-1 completes the first learning operation (step S107). The compensation value generation circuit 125-1 continuously outputs the first torque compensation value TCV1 at the time point at which the first learning operation has been completed, that is, the first torque compensation value TCVI based on the first compensation value table CTBL1 at the time point at which the first learning operation has been completed.

Subsequently, the torque vibration compensator 108a performs processing illustrated in FIG. 15B. In FIG. 15B, steps S201 to S204 are processes for preparation of the second learning operation. Steps S205 to S207 are processes associated with the execution of the second learning operation. In the processes in steps S201 to S207, the first-order tracking frequency ωᵣ in the processes in steps S101 to S107 described above is changed to the second-order tracking frequency (2ωᵣ).

Briefly, in step S201, the torque vibration compensator 108a selects the double mechanical angle (2ωm), that is, the second-order tracking frequency (2θᵣ) by using the changeover switches SW1 and SW2. Accordingly, the tracking filter TFa generates the second tracking output signal Fout2 by extracting a frequency component of the second-order tracking frequency (2ωᵣ) included in the torque vibration (step S202).

Subsequently, the torque vibration compensator 108a waits for the second tracking output signal Fout2 to reach a steady state (step S203). In a case where it is determined that the second tracking output signal Fout2 is in the steady state (step S203: Yes), the monitoring circuit MNIa outputs the second learning start signal LST2 (step S204). In addition, for example, the monitoring circuit MNIa sets the output amplitude of the second tracking output signal Fout2 at the time point at which the state is determined to be the steady state to the pre-suppression amplitude A[0] illustrated in FIG. 11.

On the other hand, the compensation value generation circuit 125-2 receives the second update amount UA2 via the changeover switch SW2. In response to the second learning start signal LST2 in step S204, the compensation value generation circuit 125-2 starts the second learning operation based on the second update amount UA2 and the second tracking output signal Fout2 (step S205). The compensation value generation circuit 125-2 sequentially updates and outputs the second torque compensation value TCV2 in accordance with the second learning operation.

As a result, since the torque vibration is sequentially suppressed, the monitoring circuit MNIa outputs the second learning completion signal LCP2 at any time point. In a case where the second learning completion signal LCP2 is output (step S206: Yes), the compensation value generation circuit 125-2 completes the second learning operation (step S207). The compensation value generation circuit 125-2 continuously outputs the second torque compensation value TCV2 at the time point at which the second learning operation has been completed, that is, the second torque compensation value TCV2 based on the second compensation value table CTBL2 at the time point at which the second learning operation has been completed.

### Torque Vibration Compensator (Application Example[2])

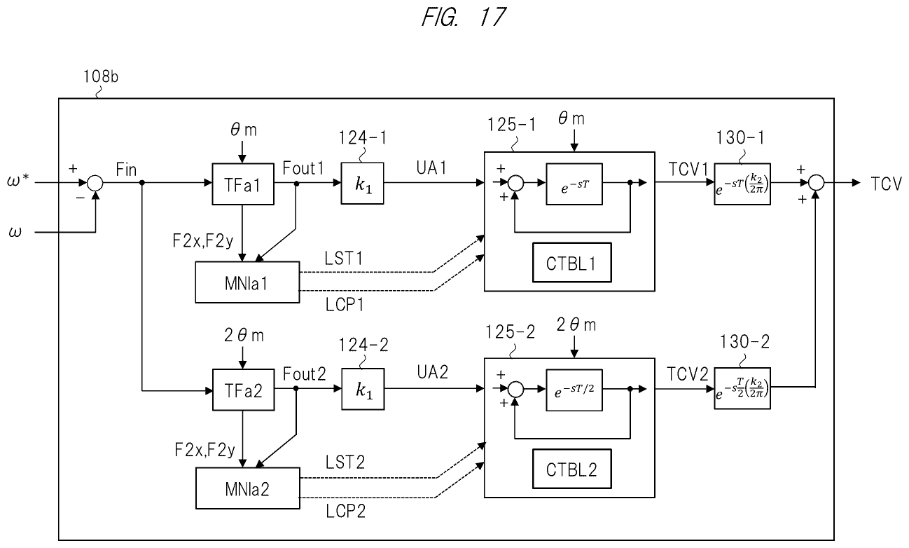

FIG. 17 is a schematic diagram illustrating a configuration example different from that in FIG. 14 in which the torque vibration compensator illustrated in FIG. 8 is extended. Also in FIG. 17, similarly to the case in FIG. 14, a plurality of tracking frequencies, in this example, the first-order tracking frequency ωᵣ and the second-order tracking frequency (2ωᵣ) are provided. Accordingly, a torque vibration compensator 108b illustrated in FIG. 17 includes two tracking filters TFa1 and TFa2 respectively corresponding to the two tracking frequencies, unlike the case in FIG. 14. Furthermore, the torque vibration compensator 108b includes two monitoring circuits MNIa1 and MNIa2 and two multipliers 124-1 and 124-2 respectively corresponding to the two tracking filters TFa1 and TFa2.

The first tracking filter TFa1 receives the mechanical angle θm to generate the first tracking output signal Fout1 by using the first-order tracking frequency ωᵣ. The first monitoring circuit MNIa1 monitors a processing state of first tracking filter TFa1 to generate the first learning completion signal LCP1. The multiplier 124-1 receives the first tracking output signal Fout1, and generates a first update amount UA1.

On the other hand, the second tracking filter TFa2 receives the double mechanical angle (2θm) to generate the second tracking output signal Fout2 by using the second-order tracking frequency (2ωᵣ). The second monitoring circuit MNIa2 monitors the processing state of the second tracking filter TFa2 to generate the second learning completion signal LCP2. The multiplier 124-2 receives the second tracking output signal Fout2, and generates the second update amount UA2.

Thereafter, as in the case in FIG. 14, processing using the two compensation value generation circuits 125-1 and 125-2 and the like is performed. Briefly, the compensation value generation circuit 125-1 starts the first learning operation by using the first update amount UA1 and the first tracking output signal Fout1 as inputs. Thereafter, the compensation value generation circuit 125-1 completes the first learning operation in response to the first learning completion signal LCP1, and continuously reflects the first torque compensation value TCV1 at the time point at which the learning operation has been completed in the motor control signal.

On the other hand, the compensation value generation circuit 125-2 starts the second learning operation in parallel with the compensation value generation circuit 125-1, by using the second update amount UA2 and the second tracking output signal Fout2 as inputs. Thereafter, the compensation value generation circuit 125-2 completes the second learning operation in response to the second learning completion signal LCP2, and continuously reflects the second torque compensation value TCV2 at the time point at which the learning operation has been completed in the motor control signal.

By using the above configuration example, for example, as in the case in FIG. 14, it is possible to suppress the first-order frequency component and the second-order frequency component included in the torque vibration. In the configuration example illustrated in FIG. 17, unlike the case in FIG. 14, since the first-order and second-order frequency components are suppressed through parallel processing by using different resources, for example, the time required for suppressing the torque vibration can be shortened. On the other hand, in the configuration example illustrated in FIG. 14, unlike the case in FIG. 17, since the first-order and second-order frequency components are suppressed through the series processing by using the common resource, the overhead of a circuit area or a processing load caused by the processor PRC can be reduced. Although the frequency components up to the second order are suppressed in FIGS. 14 and 17, frequency components of third-order and subsequent orders can be similarly suppressed.

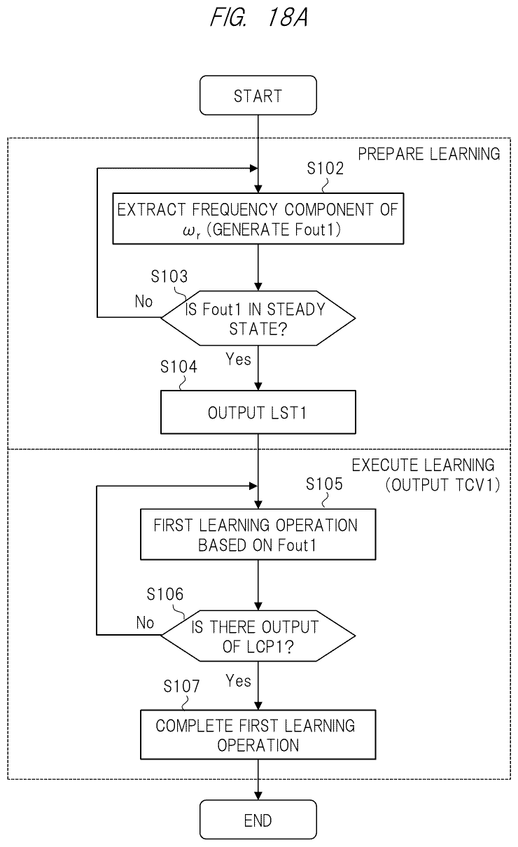

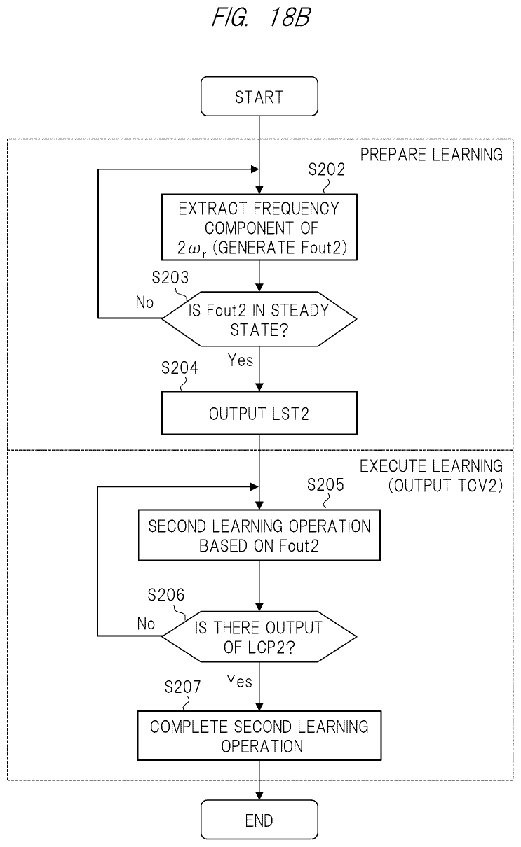

FIG. 18A is a flowchart illustrating an example of processing content of a main part of the torque vibration compensator 108b illustrated in FIG. 17. FIG. 18B is a flowchart illustrating an example of processing content subsequent to FIG. 18A. For example, the processor PRC in FIG. 5 executes these processes on the basis of a program in the memory MEM. In the flow illustrated in FIG. 18A, the process in step S101 is deleted from the flow illustrated in FIG. 15A. The processes in steps S102 to S104 are performed by the first tracking filter TFa1 and the first monitoring circuit MNIa1.

Similarly, in the flow illustrated in FIG. 18B, the process in step S201 is deleted from the flow illustrated in FIG. 15B. Furthermore, the flow illustrated in FIG. 18B is executed in parallel with the flow illustrated in FIG. 18A, unlike the case in FIG. 15B. In FIG. 18B, the processes in steps S202 to S204 are performed by the second tracking filter TFa2 and the second monitoring circuit MNIa2.

### Torque Vibration Compensator (Modification Example)

In the above description, for example, the torque vibration compensator 108 performs the learning operation for suppressing the torque vibration at the startup stage of the motor system or the like, and continuously outputs the torque compensation value TCV at the time of completion of the learning operation after the learning operation is completed. In this case, the tracking filter TFa and the monitoring circuit MNIa do not particularly need to operate after completion of the learning operation. However, the tracking filter TFa and the monitoring circuit MNIa may continue the operation after the learning operation is completed. In this case, the torque vibration compensator 108 may perform the learning operation again, for example, when there is a large change in the abnormality indexes IDXx and IDXy or the suppression ratio SR.

### Application Example to Other Systems

The semiconductor device 10 illustrated in FIG. 1 can be applied not only to the application of f suppressing torque vibration in the motor system as described above but also to various applications in various systems. As an example, the semiconductor device 10 can be applied to an application of malfunction prevention in a control system of a magnetic bearing. In this case, the tracking filter is mainly used for controlling a magnetic bearing. In the control of the magnetic bearing, a phenomenon (imbalance force) in which a shaft vibrates outward from the center position due to a centrifugal force at the time of high-speed rotation mainly occurs due to a minute imbalance weight present in a magnetically levitated shaft/rotor.

Here, the semiconductor device 10 can be applied to a compensation device for canceling out the imbalance force. In this case, the semiconductor device 10 can detect a frequency component other than the tracking frequency ωᵣ representing a force other than the imbalance force, that is, an AC component, for example, at the time of starting or at a low speed. For example, in a case where the AC component is large, the semiconductor device 10 can prevent overcompensation or the like by disabling the function of canceling out the centrifugal force.

### Main Effects of Embodiment

As described above, the semiconductor device according to the embodiment includes the tracking filter including the low-pass filter, and the monitoring circuit that determines whether or not the tracking filter is abnormal by detecting an AC component included in an output signal of the low-pass filter. Consequently, it is possible to prevent malfunction of the system equipped with the tracking filter. The safety of the system can be further enhanced. In particular, by suppressing torque vibration in the motor system by using the semiconductor device, it is possible to prevent a situation in which the tracking filter itself functions as an unintended vibration source. As a result, the torque vibration can be more reliably suppressed.

Although the invention made by the present inventors has been specifically described on the basis of the embodiments, the present invention is not limited to the above embodiments, and various modifications can be made without departing from the spirit of the present invention. For example, the above-described embodiments have been described in detail in order to describe the present invention in an easy-to-understand manner, and are not necessarily limited to those having all the described configurations. A part of the configuration of one embodiment can be replaced with the configuration of another embodiment, and the configuration of another embodiment can be added to the configuration of one embodiment. In addition, it is possible to add, delete, and replace other configurations for a part of the configuration of each embodiment.

Each unit is typically implemented by program processing using a central processing unit (CPU). That is, each unit is implemented on the CPU by the CPU executing the program stored in the memory. However, the implementation form of each unit is not limited to such software, and may be, for example, hardware such as a field programmable gate array (FPGA) or an application specific integrated circuit (ASIC), or may be a combination of software and hardware.

Furthermore, the program described above can be stored in a non-transitory tangible computer-readable recording medium and then supplied to the computer. Examples of such a recording medium include a magnetic recording medium typified by a hard disk drive or the like, an optical recording medium typified by a digital versatile disc (DVD), a Blu-ray disc, or the like, and a semiconductor memory typified by a flash memory, a solid state drive (SSD), or the like.

What is claimed is:

1. A semiconductor device comprising:
a tracking filter that extracts a frequency component of a tracking frequency from a tracking input signal including a plurality of frequency components and generates a tracking output signal including the extracted frequency component of the tracking frequency; and
a monitoring circuit that monitors a processing state of the tracking filter,
wherein the tracking filter includes:
an extraction multiplier that multiplies the tracking input signal by a cosine wave signal or a sine wave signal having the tracking frequency;
a low-pass filter that removes a frequency component higher than a cutoff frequency from an output signal of the extraction multiplier; and
a restoration multiplier that multiplies an output signal of the low-pass filter by the cosine wave signal or the sine wave signal having the tracking frequency to generate the tracking output signal, and
wherein the monitoring circuit detects an AC component included in an output signal of the low-pass filter, and, determines whether or not the tracking filter is abnormal on the basis of a magnitude of the detected AC component.

2. The semiconductor device according to claim 1,
wherein the monitoring circuit
detects a DC component included in the output signal of the low-pass filter,
calculates a ratio of the AC component to the DC component as an abnormality index, and
determines whether or not the tracking filter is abnormal on the basis of the abnormality index.

3. The semiconductor device according to claim 2,
wherein the monitoring circuit determines that there is an abnormality in a case where the abnormality index is higher than a predetermined threshold, and determines that there is no abnormality in a case where the abnormality index is lower than the threshold.

4. The semiconductor device according to claim 1,
wherein the extraction multiplier includes a first multiplier that multiplies by the cosine wave signal and a second multiplier that multiplies by the sine wave signal,
wherein the low-pass filter includes a first low-pass filter that receives an output signal of the first multiplier and a second low-pass filter that receives an output signal of the second multiplier, and
wherein the monitoring circuit detects a first AC component included in the output signal of the first low-pass filter and a second AC component included in the output signal of the second low-pass filter, and determines whether or not the tracking filter is abnormal on the basis of a magnitude of at least one of the first AC component and the second AC component.

5. The semiconductor device according to claim 1,
wherein a plurality of the tracking frequencies are provided, and
wherein the tracking filter generates a plurality of the tracking output signals in a time division manner by switching between the plurality of tracking frequencies.

6. The semiconductor device according to claim 1,
wherein a plurality of the tracking frequencies are provided, and
wherein the semiconductor device includes:
a plurality of the tracking filters respectively corresponding to the plurality of tracking frequencies; and
a plurality of the monitoring circuits respectively corresponding to the plurality of tracking filters.

7. A semiconductor device comprising:
a memory storing a program; and
a processor that executes the program stored in the memory,
wherein the processor, on the basis of the program, executes
(a) a tracking process of extracting a frequency component of a tracking frequency from a tracking input signal including a plurality of frequency components and generating a tracking output signal including the extracted frequency component of the tracking frequency, and
(b) a monitoring process of monitoring a processing state of the tracking process, wherein the tracking process of (a) includes:
(a1) multiplying the tracking input signal by a sine wave signal or a cosine wave signal of the tracking frequency;
(a2) removing a frequency component of a frequency higher than a cutoff frequency from the output signal obtained in the (a1); and
(a3) generating the tracking output signal by multiplying the output signal obtained in the (a2) by a sine wave signal or a cosine wave signal of the tracking frequency, and
wherein the monitoring process of (b) includes
detecting an AC component included in the output signal obtained in the (a2) and determining whether or not the tracking process is abnormal on the basis of a magnitude of the detected AC component.

8. The semiconductor device according to claim 7,
wherein, in the monitoring process of (b), the processor
detects a DC component included in the output signal obtained in the (a2),
calculates a ratio of the AC component to the DC component as an abnormality index, and
determines whether or not the tracking process is abnormal on the basis of the abnormality index.

9. The semiconductor device according to claim 8,
wherein the processor determines that there is an abnormality in a case where the abnormality index is higher than a predetermined threshold, and determines that there is no abnormality in a case where the abnormality index is lower than the threshold.

10. A semiconductor device that outputs a motor control signal to an inverter that supplies power to a motor and controls the motor via the inverter, the semiconductor device comprising:
a tracking filter that receives a speed deviation between a preset speed command value and a value of a rotation speed of the motor as a tracking input signal, extracts a frequency component of a tracking frequency that is a suppression target of torque vibration from the tracking input signal, and generates a tracking output signal including the extracted frequency component of the tracking frequency;
a monitoring circuit that monitors a processing state of the tracking filter; and
a compensation value generation circuit that generates a compensation value for suppressing the torque vibration while sequentially updating the compensation value through a learning operation using the tracking output signal as an input, and reflects the generated compensation value in the motor control signal,
wherein the tracking filter includes:
an extraction multiplier that multiplies the tracking input signal by a sine wave signal or a cosine wave signal having the tracking frequency;
a low-pass filter that removes a frequency component of a frequency higher than a cutoff frequency from an output signal of the extraction multiplier; and
a restoration multiplier that generates the tracking output signal by multiplying an output signal of the low-pass filter by a sine wave signal or a cosine wave signal having the tracking frequency,
wherein the monitoring circuit detects an AC component included in the output signal of the low-pass filter, determines whether or not the tracking filter is abnormal on the basis of a magnitude of the detected AC component, and generates a learning completion signal when it is determined that there is an abnormality, and
wherein the compensation value generation circuit completes the learning operation in response to the learning completion signal.

11. The semiconductor device according to claim 10,
wherein the monitoring circuit further detects an amplitude of the tracking output signal, determines whether or not the suppression of the torque vibration has been completed or the suppression has not been completed on the basis of a magnitude of the detected output amplitude, and generates the learning completion signal also in a case where it is determined that the suppression has been completed, and
wherein the compensation value generation circuit completes the learning operation according to the learning completion signal, and continuously reflects a compensation value at a time point at which the learning operation has been completed in the motor control signal.

12. The semiconductor device according to claim 11,
wherein the monitoring circuit further
detects a DC component included in an output signal of the low-pass filter,
calculates a ratio of the AC component to the DC component as an abnormality index,
determines that there is an abnormality when the abnormality index is higher than a predetermined first threshold, and determines that there is no abnormality when the abnormality index is lower than the first threshold.

13. The semiconductor device according to claim 11,
wherein the monitoring circuit determines the magnitude of the output amplitude at a start stage of the learning operation as a pre-suppression amplitude, sequentially calculates a ratio of the detected output amplitude to the pre-suppression amplitude as a suppression ratio while sequentially detecting the output amplitude in a process of the learning operation, determines that suppression has been completed when the suppression ratio is lower than a predetermined second threshold, and determines that suppression has not been completed when the suppression ratio is higher than the second threshold.

14. The semiconductor device according to claim 12,
wherein a plurality of the tracking frequencies including a first tracking frequency and a second tracking frequency are provided,
wherein the tracking filter generates a first tracking output signal by using the first tracking frequency, and generates a second tracking output signal by using the second tracking frequency according to a first learning completion signal that is one of the learning completion signals, and
wherein the compensation value generation circuit
starts a first learning operation by using the first tracking output signal as an input,
completes the first learning operation in response to the first learning completion signal, continuously reflects a first compensation value at a time point at which the first learning operation has been completed in the motor control signal, starts a second learning operation by using the second tracking output signal as an input,
completes the second learning operation in response to a second learning completion signal that is another one of the learning completion signals, and continuously reflects a second compensation value at a time point at which the second learning operation has been completed in the motor control signal.

15. The semiconductor device according to claim 14,
wherein the second tracking frequency is a frequency that is twice the first tracking frequency.

16. The semiconductor device according to claim 12,
wherein a plurality of the tracking frequencies including a first tracking frequency and a second tracking frequency are provided,
wherein the semiconductor device includes:
a first tracking filter and a second tracking filter respectively corresponding to the first tracking frequency and the second tracking frequency; and
a first monitoring circuit and a second monitoring circuit respectively corresponding to the first tracking filter and the second tracking filter, and
wherein the compensation value generation circuit
starts a first learning operation by using a first tracking output signal from the first tracking filter as an input, completes the first learning operation in response to a first learning completion signal from the first monitoring circuit, continuously reflects a first compensation value at a time point at which the first learning operation has been completed in the motor control signal,
starts a second learning operation by using a second tracking output signal from the second tracking filter as an input, completes the second learning operation in response to a second learning completion signal from the second monitoring circuit, and continuously reflects a second compensation value at a time point at which the second learning operation has been completed in the motor control signal.

17. The semiconductor device according to claim 16,
wherein the second tracking frequency is a frequency that is twice the first tracking frequency.

18. The semiconductor device according to claim 10, further comprising:
a speed controller that generates a torque command value such that a speed deviation between the speed command value and a value of a rotation speed of the motor approaches zero,
wherein the compensation value generation circuit adds the generated compensation value to the torque command value.
